(19) United States
(12) Patent Application Publication
(10) Pub. No.: US 2023/0352938 A1
(43) Pub. Date: Nov. 2, 2023

(54) METHODS, SYSTEMS, APPARATUSES, AND DEVICES FOR FACILITATING MANAGING INTERCONNECTION PROCESSES ON A POWER TRANSMISSION NETWORK

(71) Applicants: Jose Gonzalo Moreno, PITTSFORD, NY (US); BROBY DANIEL, GLASGOW (GB)

(72) Inventors: Jose Gonzalo Moreno, PITTSFORD, NY (US); BROBY DANIEL, GLASGOW (GB)

(21) Appl. No.: 17/733,855

(22) Filed: Apr. 29, 2022

(51) Int. Cl. H02J 3/00; H02J 13/00; G06Q 20/38; H04L 9/00; H04L 9/32; G06Q 20/40

(52) U.S. Cl. CPC H02J 3/008; H02J 3/004; H02J 13/00028; G06Q 20/389; H04L 9/50; H04L 9/3239; G06Q 20/4016; H02J 2203/10; H02J 2300/20; H02J 2310/70; H02J 13/00002; H04L 2209/56

(57) ABSTRACT

Disclosed herein is a method for facilitating managing interconnection processes on a power transmission network. Accordingly, the method may include receiving a request from a device, retrieving a transmission network data associated with a power transmission network from a distributed ledger, analyzing the request and the transmission network data, generating an updated transmission network data of the power transmission network based on the analyzing, transmitting the updated transmission network data to a second device, receiving a response corresponding to the updated transmission network data from the second device, analyzing the response using a machine learning model, generating a validation status of the request transmitting the validation status to the device and the second device, and storing at least one of the response, the updated transmission network data, the validation status, and the request in the distributed ledger.

### FIELD OF THE INVENTION

Generally, the present disclosure relates to the field of data processing. More specifically, the present disclosure relates to methods, systems, apparatuses, and devices for facilitating managing interconnection processes on a power transmission network.

### BACKGROUND OF THE INVENTION

The field of data processing is technologically important to several industries, business organizations, and/or individuals. In particular, the use of data processing is prevalent for facilitating managing interconnection processes on a power transmission network.

New Generation, Load, and Transmission Network projects aiming to be connected to the United States of America Power Grid at the Transmission level must follow the currently implemented Interconnection Processes in the area of the interconnection. These Interconnection Processes are inefficient and cause many delays to those projects and subsequently to the optimal development of the Transmission Power Network. Projects' financial viability, as well as other aspects such as security, availability, and reliability of the Power Grid, can be seriously impacted.

More than two-thirds of the electricity load served in the United States of America occurs in areas operated by the different RTO/ISOs. Developers, generators, and loads willing to connect their projects to the Transmission Network must follow the processes implemented by the ISO/RTO operating in that area. This means that the different ISOs become a bottleneck for any new project that needs to be connected to the Transmission Network: the time projects spend in ISOs queues until COD has almost doubled from an average of 1.9 years to 3.5 years in the last decade (Joseph Rand, 2021). The ISO of that area evaluates each proposal and check if upgrades are required in the existing Power Network for those Interconnections to be allowed to become part of it. This has an obvious impact on schedule and costs for each of those projects, which leads to additional impacts on other Transmission projects waiting to be connected due to changes with respect to the assumptions the ISO used for determining the best conditions for an Interconnection to be allowed. Other disadvantages of going through these processes are the lack of qualified resources ISOs have to analyze the interconnection proposals; the competition for those resources between ISOs and developers, Generators and Transmission Owners; the inefficiency of ISO repeating the modeling and studies already performed by the applicants; the lack of detail at the initial stages in the network models to be supplied to ISO; the possibility of projects not being executed after approval and consideration by ISO with the subsequent impact to other interconnection projects in the queue and ultimately to the Power Grid, among others.

According to London Economics International LLC (LLC, 2021), even with unexpected events like the COVID-19 pandemic happening, there are powerful driving forces like the decarbonization and climate change goals in the power sector, the advance of technology, and legislators working on policies and stimulus to incentive investments on clean energy, which induce increasing transmission investments on energy projects to be connected to USA power grids. The transmission infrastructure needs to grow and to be updated when aging in order to allow more renewable energy generation plants to be connected to the Power Grid and in order to make sure the power grid remains as much resilient, secure, and reliable as reasonably possible with the continuous growth in demand. During the past decade, according to FERC Financial reports as indicated by EIA (Aniti, 2021), the annual investment in the electric transmission system by major USA utilities (private companies) have increased from around $20 billion to around $40 billion, including both Operations and maintenance expenses and new projects investments.

In the United States of America developers, generators, and loads willing to connect their projects to a transmission network must follow a process implemented by an ISO/RTO operating in the area. This means that the different ISOs become a bottleneck for any new project that needs to be connected to the transmission network. Further, the ISO evaluates each proposal and checks if upgrades are required in the existing transmission (or power) network for the interconnection of the project to be allowed to become part of the transmission network. This has an impact on the schedule and costs for each of those projects, which leads to additional impacts on other transmission projects waiting to be connected.

Further, each ISO/RTO has its processes, but they are alike. Further, the ISO interacts with the transmission owner, the system operator, and other generator owners. Further, the transmission of power works as a regulated monopoly under cost-of-service or incentive-based arrangements. Further, regulators in the U.S. have been developing new rules to encourage competition and avoid vertically integrated monopolies for utilities. However, since the transmission power network is a natural monopoly, the U.S., like other countries, started enacting rules to unbundle certain activities of existing vertically integrated utilities acting as monopolies to encourage competition. Further, bodies or organizations responsible for the power system regulation and policies in the U.S. are found at the national or federal level, multi-state level, and state level. At the federal level, there is the Federal Energy Regulatory Commission (FERC) to regulate interstate electricity commerce (transfer of electricity between different States), as established in the Department 10 of Energy (DOE) Organization Act of 1977.

FERC issued Orders 888 “Promoting Wholesale Competition Through Open Access Non-discriminatory Transmission Services by Public Utilities; Recovery of Stranded Costs by Public Utilities and Transmitting Utilities.” and Order No. 889 “added and amended existing rules” in 1996, that changed the electricity market via restructuration and liberalization. Further, the electricity market moved from existing monopolies held by vertically integrated power utility companies and allowed substantial deregulation of the electric industry. Further, in 1999, FERC issued Order No 2000 establishing Regional Transmission Organizations (RTOs) and encouraged electric utilities to become members of RTOs. However, existing techniques for managing interconnection processes on a power transmission network are deficient with regard to several aspects. For instance, current technologies do not allow the RTOs to implement real-time generation and load balancing. Further, current technologies are not compliant with the North American Electric Reliability Corporation's (NERC) mission of improving the reliability and security of the Bulk-Power System in the United States, Canada, and part of Mexico. NERC is certified by FERC and it prepares and issues reliability standards as per FERC requirements and enforces their compliance.

Therefore, there is a need for improved methods, systems, apparatuses, and devices for facilitating managing interconnection processes on a power transmission network that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating managing interconnection processes on a power transmission network, in accordance with some embodiments. Accordingly, the method may include receiving, using a communication device, at least one request from at least one device associated with at least one entity. Further, the at least one entity wants to connect at least one electrical equipment to at least one power transmission network. Further, the method may include retrieving, using a storage device, a transmission network data associated with the at least one power transmission network from a distributed ledger based on the at least one request. Further, the method may include analyzing, using a processing device, the at least one request and the transmission network data. Further, the method may include generating, using the processing device, an updated transmission network data of the at least one power transmission network based on the analyzing of the at least one request and the transmission network data. Further, the updated transmission network data reflects an impact on the at least one power transmission network by connecting the at least one electrical equipment to the at least one power transmission network. Further, the method may include transmitting, using the communication device, the updated transmission network data to at least one second device. Further, the at least one second device may be associated with a plurality of validators. Further, the method may include receiving, using the communication device, at least one response corresponding to the updated transmission network data from the at least one second device. Further, the method may include analyzing, using the processing device, the at least one response using at least one machine learning model. Further, the at least one machine learning model may be based on a consensus algorithm. Further, the method may include generating, using the processing device, a validation status of the at least one request for the connecting of the at least one electrical based on the analyzing of the at least one response. Further, the method may include transmitting, using the communication device, the validation status to at least one of the at least one device and the at least one second device. Further, the method may include storing, using the storage device, at least one of the at least one response, the updated transmission network data, the validation status, and the at least one request in the distributed ledger.

Further disclosed herein is a system for facilitating managing interconnection processes on a power transmission network, in accordance with some embodiments. Accordingly, the system may include a communication device configured for receiving at least one request from at least one device associated with at least one entity. Further, the at least one entity wants to connect at least one electrical equipment to at least one power transmission network. Further, the communication device may be configured for transmitting an updated transmission network data to at least one second device. Further, the at least one second device may be associated with a plurality of validators. Further, the communication device may be configured for receiving at least one response corresponding to the updated transmission network data from the at least one second device. Further, the communication device may be configured for transmitting a validation status to at least one of the at least one device and the at least one second device. Further, the system may include a processing device communicatively coupled to the communication device. Further, the processing device may be configured for analyzing the at least one request and a transmission network data. Further, the processing device may be configured for generating the updated transmission network data of the at least one power transmission network based on the analyzing of the at least one request and the transmission network data. Further, the updated transmission network data reflects an impact on the at least one power transmission network by connecting the at least one electrical equipment to the at least one power transmission network. Further, the processing device may be configured for analyzing the at least one response using at least one machine learning model. Further, the at least one machine learning model may be based on a consensus algorithm. Further, the processing device may be configured for generating the validation status of the at least one request for the connecting of the at least one electrical based on the analyzing of the at least one response. Further, the system may include a storage device communicatively coupled with the processing device. Further, the storage device may be configured for retrieving the transmission network data associated with the at least one power transmission network from a distributed ledger based on the at least one request. Further, the storage device may be configured for storing at least one of the at least one response, the updated transmission network data, the validation status, and the at least one request in the distributed ledger.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flow chart of a method for facilitating managing interconnection processes on a power transmission network, in accordance with some embodiments.

FIG. 3 is a flow chart of a method for facilitating managing interconnection processes on the power transmission network, in accordance with some embodiments.

FIG. 4 is a flow chart of a method for facilitating managing interconnection processes on the power transmission network, in accordance with some embodiments.

FIG. 5 is a flow chart of a method for facilitating managing interconnection processes on the power transmission network, in accordance with some embodiments.

FIG. 6 is a flow chart of a method for facilitating managing interconnection processes on the power transmission network, in accordance with some embodiments.

FIG. 7 is a flow chart of a method for facilitating managing interconnection processes on the power transmission network, in accordance with some embodiments.

FIG. 8 is a flow chart of a method for facilitating managing interconnection processes on the power transmission network, in accordance with some embodiments.

FIG. 9 is a block diagram of a system for facilitating managing interconnection processes on a power transmission network, in accordance with some embodiments.

FIG. 10 is a block diagram of the system for facilitating managing interconnection processes on a power transmission network, in accordance with some embodiments.

FIG. 11 is a block diagram of the system for facilitating managing interconnection processes on a power transmission network, in accordance with some embodiments.

FIG. 12 is a block diagram of the system for facilitating managing interconnection processes on a power transmission network, in accordance with some embodiments.

FIG. 13 is a flow diagram of a method for facilitating power network interconnection and optimization, in accordance with some embodiments.

FIG. 14 is a flow diagram of a method for automatic execution of smart contracts in blockchain for the new transmission network interconnection process, in accordance with some embodiments.

FIG. 15 is a schematic of a system for facilitating power network interconnection and optimization, in accordance with some embodiments.

FIG. 16 is a flow diagram of a method for facilitating a new applicant for requesting access to the blockchain network, in accordance with some embodiments.

FIG. 17 illustrates a graph of annual spending on U.S. transmission power network by major utilities between 2010 and 2020.

FIG. 18 illustrates a graph of base and incremental annual transmission project investments.

FIG. 19 is a flowchart of a process for NYISO large facilities interconnection qualification.

FIG. 20 is a continuation flowchart of the process for the NYISO large facilities interconnection qualification.

FIG. 21 illustrates a table of completed and withdrawn interconnection projects in the U.S.

FIG. 22 illustrates an architecture of a decentralized network.

FIG. 23 illustrates components of blocks in the Blockchain.

FIG. 24 is a table illustrating four types of Blockchain.

FIG. 25 is a table illustrating some characteristics of main distributed consensus algorithms.

FIG. 26 is a flow diagram of a method for illustrating the working of blockchain oracles.

FIG. 27 illustrates electricity market regulation bodies in the U.S and roles played by the electricity market regulation bodies.

FIG. 28 illustrates 9 ISOs/RTOs in the U.S. and regions of the 9 ISOs/RTOs.

FIG. 29 is a flow diagram of a method of first steps of the NYISO interconnection process.

FIG. 30 is a table illustrating the NYISO interconnection process fess.

FIG. 31 is a table illustrating extract from the NYISO interconnection queue.

FIG. 32 is a table illustrating pros and cons of the current ISO interconnection process.

FIG. 33 illustrates one of the polls directed to interconnection processes experts in an internet professional network.

FIG. 34 is a table illustrating quantitative and qualitative data obtained after the three polls.

FIG. 35 illustrates a Common Network Model for different departments in a Power Utility.

FIG. 36 illustrates main characteristics of the chainlink network.

FIG. 37 illustrates a SWOT analysis of the new interconnection process, in accordance with some embodiments.

FIG. 38 is a flow diagram of a new process for NYISO interconnection, in accordance with some embodiments.

FIG. 39 is a continuation flow diagram of the new process for the NYISO interconnection, in accordance with some embodiments.

FIG. 40 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating managing interconnection processes on a power transmission network, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices for facilitating managing interconnection processes on a power transmission network. Further, the disclosed system may be configured for power network interconnection and optimization. Further, the disclosed system may allow any developer, generator, load, or transmission owner (applicants) to request access to an existing transmission network. In addition, the disclosed system may eliminate the need for a centralized supervisory entity while having all necessary parties engaged with the process as active participants, assuring the transmission network's reliability, availability, and security are not jeopardized. Further, two key elements associated with the disclosed system may include an acknowledgment that there may be constraints in a new competitive wholesale market and initiatives appeared to create Independent System Operators (ISO) to deal with those constraints—and that if vertically integrated monopolistic companies had to allow access to their transmission networks to transport electricity generated by third parties, then the companies should be compensated and a cost of service be paid to them.

Further, the disclosed system may include a transmission network, a network database, a computer-implemented system housing a private permissioned blockchain, and a validator processor. Further, the private permissioned blockchain allows a data model (or model) of an existing transmission power system to be stored and available to all nodes. Further, participants in the blockchain are responsible for maintaining and updating the model in a ledger. Further, the data model together with all the necessary data/information may be stored. Further, in an instance, the model may include a 345 kV line, double circuit, between two substations. Further, additional data assigned to the line may also be stored/included, like a length of the line, a record of past outages, a number of conductors, a type of conductor, a record of maintenance work done, etc.). The disclosed system and its application by the processor represent a useful improvement on exiting systems.

Optionally, method nodes that are validators may be known and confirmed by a notary service (ISO/RTO in this case). Further, the disclosed system may be implemented as a server or a plurality of servers. Optionally, the disclosed system may be adapted for other grids outside of the United States. Further, the system may be extended not only to the whole transmission power network but also to the distribution power networks (at a lower voltage level).

Further, the transmission network may be based on a data blockchain with a consensus algorithm. Further, it is partially centralized (only a small group of validators may embed blocks), which preserves the criticality of the information. Further, the private permissioned blockchain may be used to maintain the information of the transmission power network (or the transmission network). Although throughput is low (80 TPS) and scalability is stable (about 8 seconds to validate a block even with more than one thousand nodes in the network), the value of these two characteristics is more than enough for the transmission network blockchain.

Further, the disclosed system may be configured for power network interconnection optimization resulting in automatic control sequences. Further, the disclosed system may include a processor configured to run a multiplicity of power optimization equipment. Further, the disclosed system may be associated with a query system for storing, monitoring, and analyzing and for use with the predictive modeling for optimized power transmission timing, management, storage, and distribution. Further, the disclosed system may include a database configured to store regulatory data. Further, the disclosed system may include a memory for storing instructions located centrally or distributed over a network for storage on a blockchain. Further, the disclosed system may include a device for monitoring and real-time response. Further, the disclosed method may be associated with a blockchain-implemented method that may include storing data. Further, the blockchain implemented method may include retrieving data. Further, the blockchain implemented method may include verifying applications and keeping information private. Further, blockchain networks are considered very secure due to the cryptography used by the blockchain network and the role of a consensus algorithm. Further, using Chainlink as the off-chain data provider for smart contracts increases security.

Further, the disclosed system may be associated with a transmission network data model available to every blockchain network participant (or network participant) to check, and also having always ISO/RTO as the main validator node gives consistency. Further, smart contracts associated with the disclosed system may be immutable, giving additional consistency to the system. Further, the disclosed system may be associated with the consensus algorithm and trusted validating nodes. Further, the transmission network data model (or network data model and data) may be accessible (reading rights) to all nodes in the blockchain network. Further, privacy may be a bit compromised since the disclosed system may be associated with a private network. There is more privacy with the external world, but it may be considered that the network participants may see which are the nodes/participants may be proposing additions/modifications to the transmission network data model (or data) in a blockchain ledger associated with the blockchain network. This also allows the network participants to be able to prepare the necessary studies when applying for new transmission interconnections with the most updated information/model. Further, the disclosed system may be quicker. It is still necessary for ISO/RTO and others to review the studies and interconnection data submitted, but each Developer may be preparing them that may be much quicker. Further, the cost associated with the disclosed system may be the same for applicants, because they need to prepare the studies anyway in advance of the interconnection request application, thus the network participant has studied the potential implications when working on the business case. Further, utilities and all other transmission network participants may implement a common network model and database in their companies. Further, a blockchain network type associated with the blockchain network has not been defined. Further, the blockchain network type may be left open to further research and analysis. Further, the private permissioned blockchain network may be based on Ethereum that may have smart contacts implemented. Further, a selection of the blockchain (whether an existing one or a new one to be developed) may include a consensus algorithm. Further, the Chainlink may be proposed as the oracle network for avoiding blockchain oracle problems. But in the end, the data is being gathered from a single point of source (such as an ISO/RTO interconnection portal), that is not expected to be malicious (unless hacked), but can be down at some point, introducing a single point of failure. Further, characteristics associated with the disclosed system may be left open for the possibility of sending the network studies to be prepared by a developer as off-chain information, as it is not considered advantageous to have that information included in the blockchain. Further, it may add more information. Further, some of those studies may require several iterations until they are considered final and are validated. Further, the development of the blockchain, APIs, and smart contracts may take between 1 to 3 years. Further, the longest period may likely be consumed by the current transmission network participants to understand, agree, and collaborate to make the blockchain network functional.

Further, in an embodiment, a first component, a second component, a third component, and a fourth component associated with the disclosed system may be separate devices.

Further, the disclosed system may be configured for power transmission optimization. Further, the disclosed system may be configured for connecting a new facility to a Transmission Power Network. The disclosed system includes the processor, the query system, the database, and the memory. The system incorporates a blockchain Chainlink. The processor represents an improvement on traditional approaches as the creation of a private permissioned blockchain network containing an ISO/RTO region's transmission network data model and database that may be read by the nodes (or participants) connected to the blockchain network. Those participants (ISO/RTO, Transmission Owners, system operators, Generators, etc.) may be connected to the transmission power network. Further, loads may be connected to the transmission power network. Further, developers willing to get connected to the transmission power network may be approved before they can join the blockchain network based on an approval process. Further, the approval process may be implemented with a dedicated smart contract between the ISO/RTO and a new participant willing to get connected.

Further, the present disclosure describes power network interconnection optimization through blockchain.

Further, the present disclosure describes a new proposal for replacing current interconnection processes using blockchain technology. Further, the Interconnection Processes are the processes that must be followed whenever a new installation or Project wants to get connected to the Transmission Power network in the U.S.

Further, the present disclosure describes an improved process that maintains the ability for any Developer, Generator, Load, or Transmission Owner (Applicants) to request access to the existing Transmission Network. In addition, the improved process eliminates the need for a centralized supervisory entity while having all necessary parties engaged with the process as active participants, assuring the Transmission Network's reliability, availability, and security are not jeopardized.

Further, the improved process may implement Blockchain technology to develop and maintain a distributed information network that contains a model of the Transmission Power Network and where applicants can request interconnection access for their new projects. Existing parties connected to the Transmission Network, TOs, and SOs, in addition to other projects applicants, can also evaluate the Interconnection proposals and decide about them. Further, the present disclosure describes a common network model for the Transmission Network in a distributed ledger and changes the currently centralized process where the corresponding ISO leads the whole process to a new one where the applicants are the ones leading it. Incentives and cost estimates of the transmission network market are considered to realize the market economic size this new approach can impact. The applicant pursuing an Interconnection to the Transmission Network proposes a viable solution that complies with all ISO's requirements. In order for this to be possible, all applicants, as well as connected participants, TOs, and SOs must have access to the most updated network model including all interconnection applications in process before the one is considered. New applicants shall update the shared network model in new blocks of information acting as a decentralized database using peer to peer communications, for the rest of the authorized peers to validate.

One first point is that the blockchain network type has not been defined. It has been left open to further research and analysis. It seems more advantageous a private permissioned blockchain network based on Ethereum that can have smart contacts implemented. The selection of the blockchain (whether an existing one or a new one to be developed) must include a consensus algorithm

A second point is that Chainlink has been proposed as the oracle network to avoid the blockchain oracle problem, but in the end, the data is being gathered from a single point of source (the ISO/RTO interconnection portal), which is not expected to be malicious (unless hacked), but can be down at some point, introducing a single point of failure.

A third point is that it has been left open the possibility of sending the network studies to be prepared by the Developer as off-chain information, as it is not considered advantageous to have that information included in the blockchain. It would add more information and some of those studies might require several iterations until they are considered final and are validated.

A fourth point is that it has been proposed that utilities and all other transmission network participants implement a common network model and database in their companies. Although as analyzed in (Gonzalo Moreno, 2020) it could be beneficial for these companies, the power sector is a very conservative one and the information is considered critical, so it is not easy to convince them to move to such a solution, as it was reflected in the second poll, where all respondents indicated they were not planning on implementing such common network model.

A fifth point is that it has not been discussed or estimated the amount of time such a solution could be implemented. Not enough data is available, and although it could be estimated that the development of such blockchain, APIs, and smart contracts could take between 1 to 3 years, it is likely that the longest period of time would be the current transmission network participants to understand, agree and collaborate in order to make such blockchain network functional.

A sixth point is that has not been discussed or estimated the costs of implementing this solution. Again, (Gonzalo Moreno, 2020) gives an estimate for implementing a similar common network model—not blockchain-based—at a company level. Not enough data is available for a proper estimate.

The seventh point of discussion is the format for the common network model/database to be used. Further, CIM model, SCL, or a mix of both is proposed, but further analysis is required to confirm it is the most convenient option.

The eighth point of discussion is the aim of this proposal was to maintain and even increase the advantages of the current processes and reduce and even eliminate the disadvantages. Checking first the advantages:
Security: blockchain networks are considered very secure due to the cryptography they use and the role of the consensus algorithms. Using Chainlink as the off-chain data provider for smart contracts increases also security.
Consistency: having a transmission network data model available to every blockchain network participant to check and also having always ISO/RTO as the main validator node gives consistency. Smart contracts are immutable, giving additional consistency to the proposal.
Consensuated Process: There is a consensus algorithm and trusted validating nodes.
Accessible: the network data model and data are accessible (reading rights) to all nodes in the blockchain network.
Privacy: privacy is a bit compromised since a private network is proposed. There is more privacy with the external world, but it could be considered that network participants may see which are the nodes/participants proposing additions/modifications to the data in the blockchain ledger.
Duration: this is a new advantage. The proposed process should be quicker. There is still necessary for ISO/RTO and others to review the studies and interconnection data submitted but is each Developer the one preparing them, which is much quicker.

A quick check on the original disadvantages:
Timing: Timing is significantly reduced as explained in the last advantage point.
Centralization: although not fully distributed, the role of ISO/RTO in the interconnection process is reduced to the main validator. The blockchain network can be defined as a decentralized semi-distributed solution.
Lack of Transparency: it is eliminated since the Developers (Interconnection applicants) are the ones preparing all the studies, reports, data, and updating the network data model and database. Validation is not done only by ISO/RTO, but other validators participate as well.
Uncertainty: the new process uses smart contracts, which are immutable, tamper-proof, and executed automatically. In addition, as Developers prepare all documentation, uncertainty is greatly reduced.
Expensive: only certain non-refundable application fees are maintained. Since ISOs/RTOs do not prepare the studies anymore, the costs associated with them are eliminated.

The characteristics of the new proposed process can maintain, improve and increase the advantages of the current interconnection processes and eliminate the currently identified disadvantages, as shown above.

Further, the present disclosure describes maintaining the existing Interconnection Processes and even improving the current advantages, by developing and maintaining a Common Network model in a secure Database that reproduces the real Transmission Power Network.

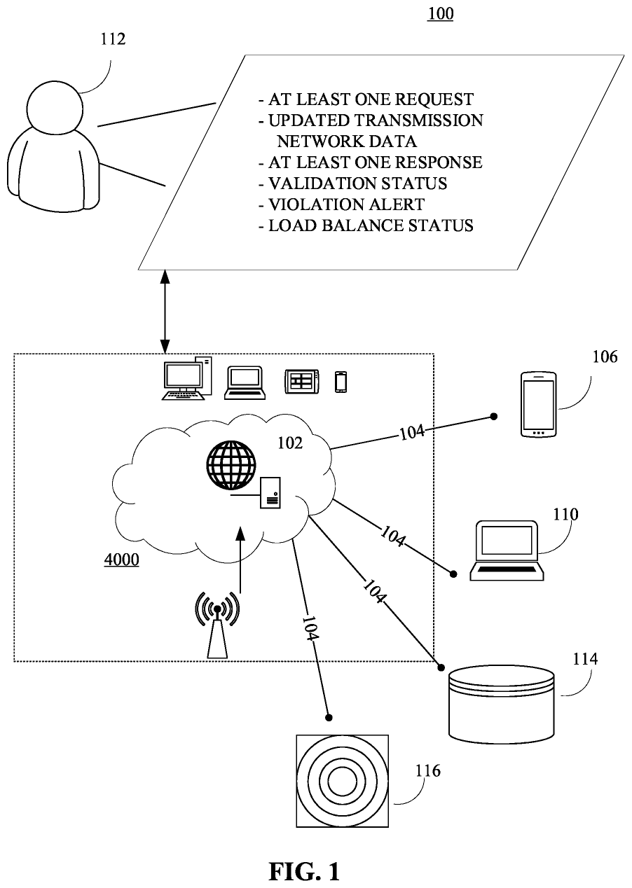

FIG. 1 is an illustration of an online platform 100 consistent with various embodiments of the present disclosure. By way of non-limiting example, the online platform 100 for facilitating managing interconnection processes on a power transmission network may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 4000.

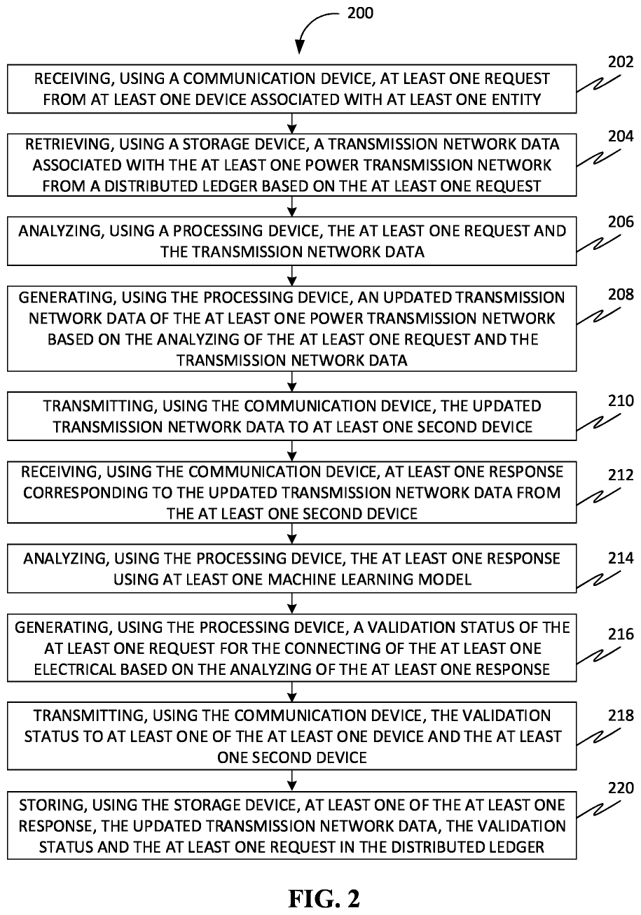

FIG. 2 is a flow chart of a method 200 for facilitating managing interconnection processes on a power transmission network, in accordance with some embodiments. Accordingly, at 202, the method 200 may include receiving, using a communication device (such as a communication device 902), at least one request from at least one device (such as at least one device 1002) associated with at least one entity. Further, the at least one request may include a request for performing at least one interconnection process on at least one power transmission network. Further, the at least one interconnection process may include at least one of connecting and disconnecting at least one electrical equipment to the at least one power transmission network. Further, the at least one entity may include a developer, a generator, a load owner, a transmission owner (applicants), etc. Further, the at least one entity wants to connect the at least one electrical equipment to the at least one power transmission network. Further, at 204, the method 200 may include retrieving, using a storage device (such as a storage device 906), a transmission network data associated with the at least one power transmission network from a distributed ledger based on the at least one request. Further, the transmission network data may include a network model of the at least one power transmission network. Further, at 206, the method 200 may include analyzing, using a processing device (such as a processing device 904), the at least one request and the transmission network data. Further, at 208, the method 200 may include generating, using the processing device, an updated transmission network data of the at least one power transmission network based on the analyzing of the at least one request and the transmission network data. Further, the updated transmission network data may include an updated network model of the at least one transmission network. Further, the updated transmission network data reflects an impact on the at least one power transmission network by connecting the at least one electrical equipment to the at least one power transmission network. Further, at 210, the method 200 may include transmitting, using the communication device, the updated transmission network data to at least one second device (such as at least one second device 1004). Further, the at least one second device may be associated with a plurality of validators. Further, at 212, the method 200 may include receiving, using the communication device, at least one response corresponding to the updated transmission network data from the at least one second device. Further, at 214, the method 200 may include analyzing, using the processing device, the at least one response using at least one machine learning model. Further, the at least one machine learning model may be based on a consensus algorithm. Further, at 216, the method 200 may include generating, using the processing device, a validation status of the at least one request for the connecting of the at least one electrical based on the analyzing of the at least one response. Further, at 218, the method 200 may include transmitting, using the communication device, the validation status to at least one of the at least one device and the at least one second device. Further, at 220, the method 200 may include storing, using the storage device, at least one of the at least one response, the updated transmission network data, the validation status, and the at least one request in the distributed ledger.

Further, in some embodiments, the at least one request may include at least one equipment specification corresponding to the at least one electrical equipment. Further, the at least one equipment specification may include a kVA rating, a primary voltage, a full load current, a number of phases, a length of line, and a type of conductor.

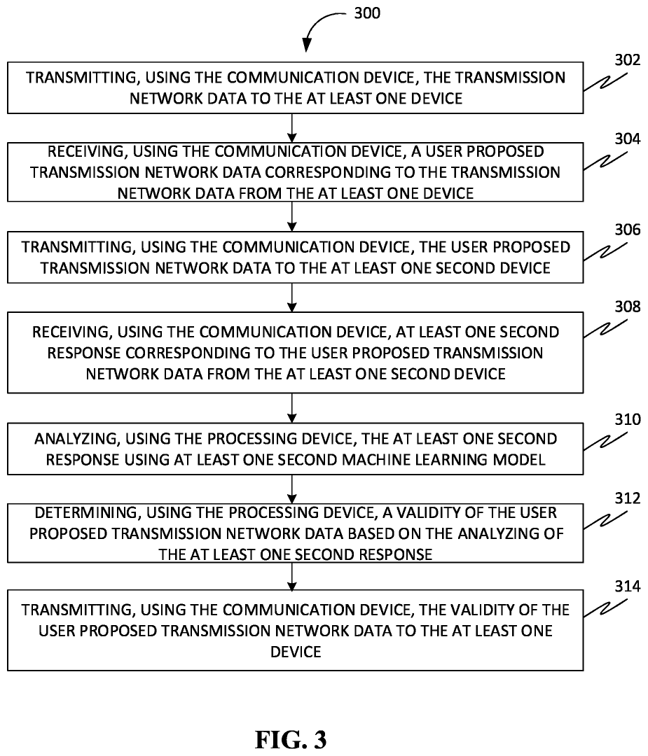

FIG. 3 is a flow chart of a method 300 for facilitating managing interconnection processes on the power transmission network, in accordance with some embodiments. Accordingly, at 302, the method 300 may include transmitting, using the communication device, the transmission network data to the at least one device. Further, at 304, the method 300 may include receiving, using the communication device, a user proposed transmission network data corresponding to the transmission network data from the at least one device. Further, at 306, the method 300 may include transmitting, using the communication device, the user proposed transmission network data to the at least one second device. Further, at 308, the method 300 may include receiving, using the communication device, at least one second response corresponding to the user proposed transmission network data from the at least one second device. Further, at 310, the method 300 may include analyzing, using the processing device, the at least one second response using at least one second machine learning model. Further, at 312, the method 300 may include determining, using the processing device, a validity of the user proposed transmission network data based on the analyzing of the at least one second response. Further, at 314, the method 300 may include transmitting, using the communication device, the validity of the user proposed transmission network data to the at least one device. Further, the generating of the validation status may be based on the validity of the user proposed transmission network data.

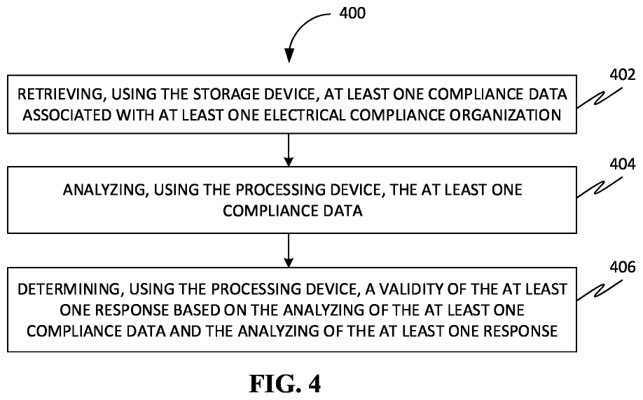

FIG. 4 is a flow chart of a method 400 for facilitating managing interconnection processes on the power transmission network, in accordance with some embodiments. Accordingly, at 402, the method 400 may include retrieving, using the storage device, at least one compliance data associated with at least one electrical compliance organization. Further, at 404, the method 400 may include analyzing, using the processing device, the at least one compliance data. Further, at 406, the method 400 may include determining, using the processing device, a validity of the at least one response based on the analyzing of the at least one compliance data and the analyzing of the at least one response. Further, the generating of the validation status of the at least one request may be based on the validity of the at least one response.

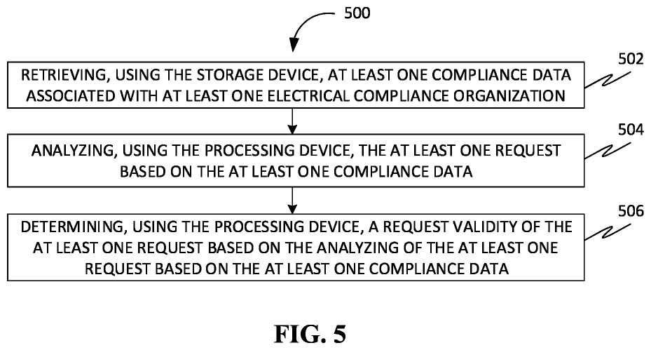

FIG. 5 is a flow chart of a method 500 for facilitating managing interconnection processes on the power transmission network, in accordance with some embodiments. Accordingly, at 502, the method 500 may include retrieving, using the storage device, at least one compliance data associated with at least one electrical compliance organization. Further, at 504, the method 500 may include analyzing, using the processing device, the at least one request based on the at least one compliance data. Further, at 506, the method 500 may include determining, using the processing device, a request validity of the at least one request based on the analyzing of the at least one request based on the at least one compliance data. Further, the retrieving of the transmission network data may be based on the request validity.

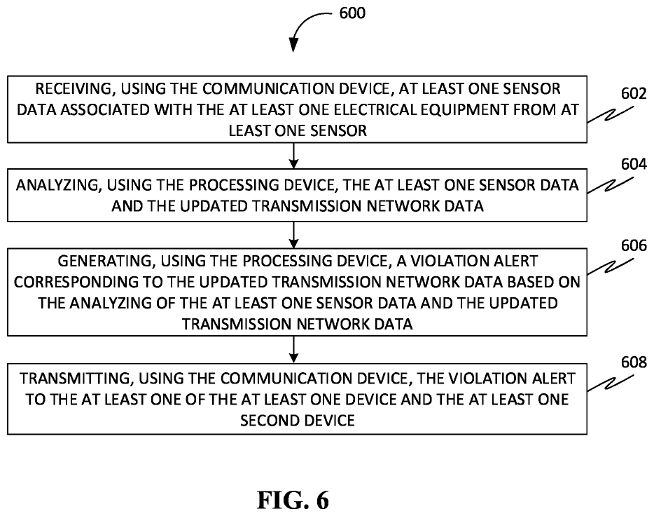

FIG. 6 is a flow chart of a method 600 for facilitating managing interconnection processes on the power transmission network, in accordance with some embodiments. Accordingly, at 602, the method 600 may include receiving, using the communication device, at least one sensor data associated with the at least one electrical equipment from at least one sensor (such as at least one sensor 1102). Further, the at least one sensor may be configured for generating the at least one sensor data based on detecting a value of at least one electrical parameter associated with the at least one electrical equipment. Further, at 604, the method 600 may include analyzing, using the processing device, the at least one sensor data and the updated transmission network data. Further, at 606, the method 600 may include generating, using the processing device, a violation alert corresponding to the updated transmission network data based on the analyzing of the at least one sensor data and the updated transmission network data. Further, at 608, the method 600 may include transmitting, using the communication device, the violation alert to the at least one of the at least one device and the at least one second device.

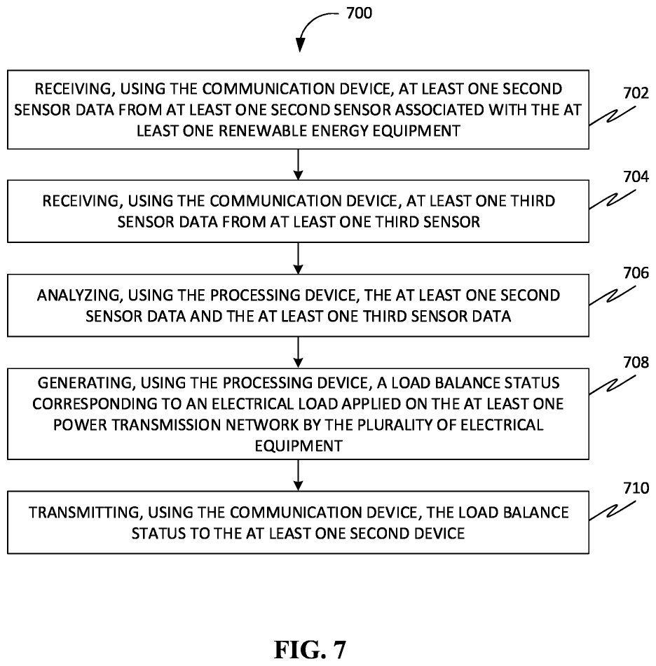

FIG. 7 is a flow chart of a method 700 for facilitating managing interconnection processes on the power transmission network, in accordance with some embodiments. Accordingly, the at least one electrical equipment may include at least one renewable energy equipment. Further, at 702, the method 700 may include receiving, using the communication device, at least one second sensor data from at least one second sensor (such as at least one second sensor 1202) associated with the at least one renewable energy equipment. Further, the at least one second sensor may be configured for generating the at least one second sensor data based on detecting a value of at least one electrical parameter associated with the at least one renewable energy equipment. Further, at 704, the method 700 may include receiving, using the communication device, at least one third sensor data from at least one third sensor (such as at least one third sensor 1204). Further, the at least one third sensor may be electrically coupled to each electrical equipment of a plurality of electrical equipment connected to the at least one power transmission network. Further, the at least one third sensor may be configured for generating the at least one third sensor data based on detecting a value of at least one equipment electrical parameter associated with each of the plurality of electrical equipment. Further, at 706, the method 700 may include analyzing, using the processing device, the at least one second sensor data and the at least one third sensor data. Further, at 708, the method 700 may include generating, using the processing device, a load balance status corresponding to an electrical load applied on the at least one power transmission network by the plurality of electrical equipment. Further, at 710, the method 700 may include transmitting, using the communication device, the load balance status to the at least one second device. Further, the transmission network data may include the load balance status.

Further, in some embodiments, the validation status may include one of a positive validation status and a negative validation status. Further, the positive validation status corresponds to an approval of the at least one request for the connecting of the at least one electrical equipment to the at least one power transmission network. Further, the negative validation status corresponds to a rejection of the at least one request for the connecting of the at least one electrical equipment to the at least one power transmission network.

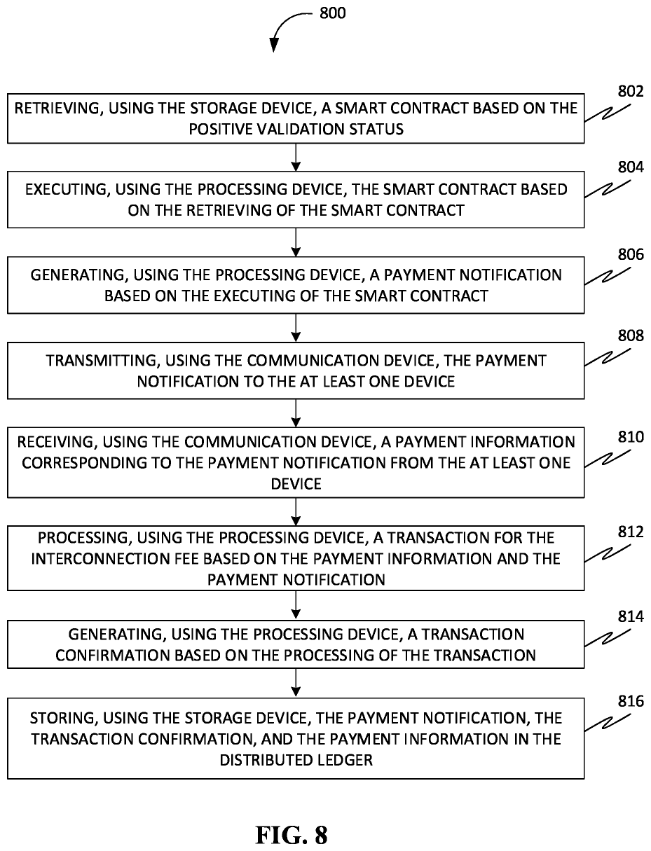

FIG. 8 is a flow chart of a method 800 for facilitating managing interconnection processes on the power transmission network, in accordance with some embodiments. Accordingly, at 802, the method 800 may include retrieving, using the storage device, a smart contract based on the positive validation status. Further, at 804, the method 800 may include executing, using the processing device, the smart contract based on the retrieving of the smart contract. Further, at 806, the method 800 may include generating, using the processing device, a payment notification based on the executing of the smart contract. Further, the payment notification may include an interconnection fee for the connecting of the at least one electrical equipment to the at least one power transmission network. Further, at 808, the method 800 may include transmitting, using the communication device, the payment notification to the at least one device. Further, at 810, the method 800 may include receiving, using the communication device, a payment information corresponding to the payment notification from the at least one device. Further, at 812, the method 800 may include processing, using the processing device, a transaction for the interconnection fee based on the payment information and the payment notification. Further, at 814, the method 800 may include generating, using the processing device, a transaction confirmation based on the processing of the transaction. Further, at 816, the method 800 may include storing, using the storage device, the payment notification, the transaction confirmation, and the payment information in the distributed ledger.

Further, in some embodiments, the payment information may include a digital wallet information associated with at least one digital wallet. Further, the at least one digital wallet stores at least one cryptocurrency. Further, the processing of the transaction may include processing a cryptographic transaction for the interconnection fee based on the digital wallet information and the payment notification. Further, the method 800 may include storing, using the storage device, the digital wallet information in the distributed ledger.

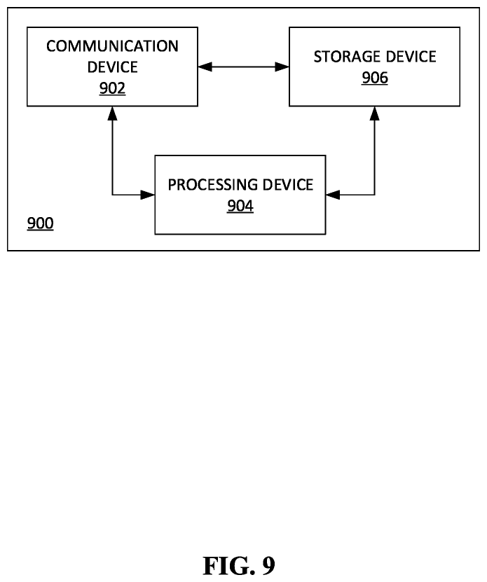

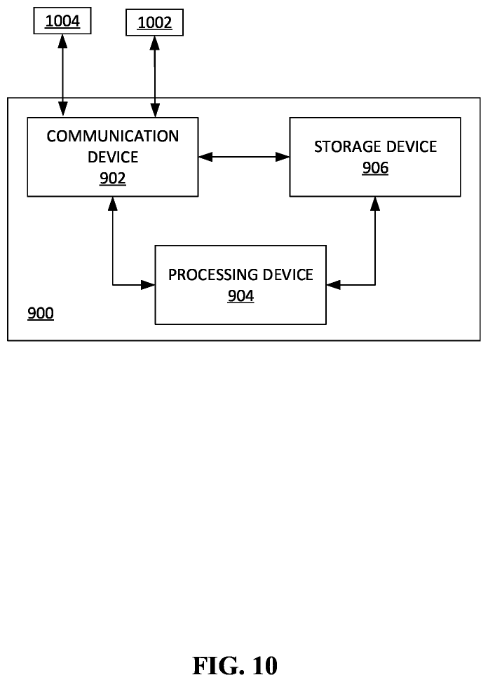

FIG. 9 is a block diagram of a system 900 for facilitating managing interconnection processes on a power transmission network, in accordance with some embodiments. Accordingly, the system 900 may include a communication device 902 configured for receiving at least one request from at least one device 1002 (as shown in FIG. 10) associated with at least one entity. Further, the at least one entity wants to connect at least one electrical equipment to at least one power transmission network. Further, the communication device 902 may be configured for transmitting an updated transmission network data to at least one second device 1004 (as shown in FIG. 10). Further, the at least one second device 1004 may be associated with a plurality of validators. Further, the communication device 902 may be configured for receiving at least one response corresponding to the updated transmission network data from the at least one second device 1004. Further, the communication device 902 may be configured for transmitting a validation status to at least one of the at least one device 1002 and the at least one second device 1004.

Further, the system 900 may include a processing device 904 communicatively coupled to the communication device 902. Further, the processing device 904 may be configured for analyzing the at least one request and a transmission network data. Further, the processing device 904 may be configured for generating the updated transmission network data of the at least one power transmission network based on the analyzing of the at least one request and the transmission network data. Further, the updated transmission network data reflects an impact on the at least one power transmission network by connecting the at least one electrical equipment to the at least one power transmission network. Further, the processing device 904 may be configured for analyzing the at least one response using at least one machine learning model. Further, the at least one machine learning model may be based on a consensus algorithm. Further, the processing device 904 may be configured for generating the validation status of the at least one request for the connecting of the at least one electrical based on the analyzing of the at least one response.

Further, the system 900 may include a storage device 906 communicatively coupled with the processing device 904. Further, the storage device 906 may be configured for retrieving the transmission network data associated with the at least one power transmission network from a distributed ledger based on the at least one request. Further, the storage device 906 may be configured for storing at least one of the at least one response, the updated transmission network data, the validation status, and the at least one request in the distributed ledger.

Further, in some embodiments, the communication device 902 may be configured for transmitting the transmission network data to the at least one device 1002. Further, the communication device 902 may be configured for receiving a user proposed transmission network data corresponding to the transmission network data from the at least one device 1002. Further, the communication device 902 may be configured for transmitting the user proposed transmission network data to the at least one second device 1004. Further, the communication device 902 may be configured for receiving at least one second response corresponding to the user proposed transmission network data from the at least one second device 1004. Further, the communication device 902 may be configured for transmitting a validity of the user proposed transmission network data to the at least one device 1002. Further, the generating of the validation status may be based on the validity of the user proposed transmission network data. Further, the processing device 904 may be configured for analyzing the at least one second response using at least one second machine learning model. Further, the processing device 904 may be configured for determining the validity of the user proposed transmission network data based on the analyzing of the at least one second response.

Further, in some embodiments, the at least one request may include at least one equipment specification corresponding to the at least one electrical equipment. Further, the at least one equipment specification may include a kVA rating, a primary voltage, a full load current, a number of phases, a length of line, and a type of conductor. Further, the at least one request may include data associated with the at least one electrical equipment such as length of the line, a record of past outages, a number of conductors, a type of conductor, a record of maintenance works done, etc.

Further, in some embodiments, the storage device 906 may be configured for retrieving at least one compliance data associated with at least one electrical compliance organization. Further, the processing device 904 may be configured for analyzing the at least one compliance data. Further, the processing device 904 may be configured for determining a validity of the at least one response based on the analyzing of the at least one compliance data and the analyzing of the at least one response. Further, the generating of the validation status of the at least one request may be based on the validity of the at least one response.

Further, in some embodiments, the storage device 906 may be configured for retrieving at least one compliance data associated with at least one electrical compliance organization. Further, the processing device 904 may be configured for analyzing the at least one request based on the at least one compliance data. Further, the processing device 904 may be configured for determining a request validity of the at least one request based on the analyzing of the at least one request based on the at least one compliance data. Further, the retrieving of the transmission network data may be based on the request validity.

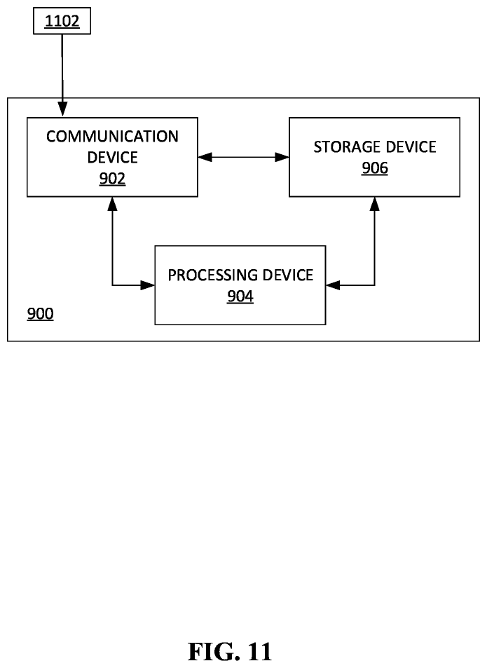

Further, in some embodiments, the communication device 902 may be configured for receiving at least one sensor data associated with the at least one electrical equipment from at least one sensor 1102 (as shown in FIG. 11). Further, the at least one sensor 1102 may be configured for generating the at least one sensor data based on detecting a value of at least one electrical parameter associated with the at least one electrical equipment. Further, the communication device 902 may be configured for transmitting a violation alert to the at least one of the at least one device 1002 and the at least one second device 1004. Further, the processing device 904 may be configured for analyzing the at least one sensor data and the updated transmission network data. Further, the processing device 904 may be configured for generating the violation alert corresponding to the updated transmission network data based on the analyzing of the at least one sensor data and the updated transmission network data.

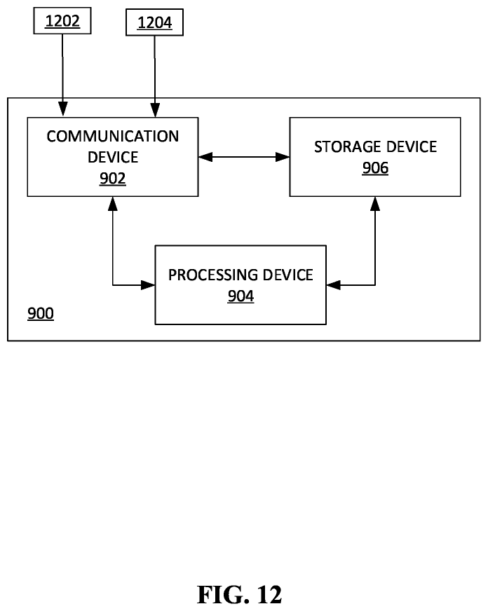

Further, in some embodiments, the at least one electrical equipment may include at least one renewable energy equipment. Further, the communication device 902 may be configured for receiving at least one second sensor data from at least one second sensor 1202 (as shown in FIG. 12) associated with the at least one renewable energy equipment. Further, the at least one second sensor 1202 may be configured for generating the at least one second sensor data based on detecting a value of at least one electrical parameter associated with the at least one renewable energy equipment. Further, the communication device 902 may be configured for receiving at least one third sensor data from at least one third sensor 1204 (as shown in FIG. 12). Further, the at least one third sensor 1204 may be electrically coupled to each electrical equipment of a plurality of electrical equipment connected to the at least one power transmission network. Further, the at least one third sensor 1204 may be configured for generating the at least one third sensor data based on detecting a value of at least one equipment electrical parameter associated with each of the plurality of electrical equipment. Further, the communication device 902 may be configured for transmitting a load balance status to the at least one second device 1004. Further, the transmission network data may include the load balance status. Further, the processing device 904 may be configured for analyzing the at least one second sensor data and the at least one third sensor data. Further, the processing device 904 may be configured for generating the load balance status corresponding to an electrical load applied on the at least one power transmission network by the plurality of electrical equipment.

Further, in some embodiments, the validation status may include one of a positive validation status and a negative validation status. Further, the positive validation status corresponds to an approval of the at least one request for the connecting of the at least one electrical equipment to the at least one power transmission network. Further, the negative validation status corresponds to a rejection of the at least one request for the connecting of the at least one electrical equipment to the at least one power transmission network.

Further, in some embodiments, the storage device 906 may be configured for retrieving a smart contract based on the positive validation status. Further, the storage device 906 may be configured for storing a payment notification, a transaction confirmation, and a payment information in the distributed ledger. Further, the processing device 904 may be configured for executing the smart contract based on the retrieving of the smart contract. Further, the processing device 904 may be configured for generating the payment notification based on the executing of the smart contract. Further, the payment notification may include an interconnection fee for the connecting of the at least one electrical equipment to the at least one power transmission network. Further, the processing device 904 may be configured for processing a transaction for the interconnection fee based on the payment information and the payment notification. Further, the processing device 904 may be configured for generating the transaction confirmation based on the processing of the transaction. Further, the communication device 902 may be configured for transmitting the payment notification to the at least one device 1002. Further, the communication device 902 may be configured for receiving the payment information corresponding to the payment notification from the at least one device 1002.

Further, in some embodiments, the payment information may include a digital wallet information associated with at least one digital wallet. Further, the at least one digital wallet stores at least one cryptocurrency. Further, the processing of the transaction may include processing a cryptographic transaction for the interconnection fee based on the digital wallet information and the payment notification. Further, the storage device 906 may be configured for storing the digital wallet information in the distributed ledger.

FIG. 10 is a block diagram of the system 900 for facilitating managing interconnection processes on a power transmission network, in accordance with some embodiments.

FIG. 11 is a block diagram of the system 900 for facilitating managing interconnection processes on a power transmission network, in accordance with some embodiments.

FIG. 12 is a block diagram of the system 900 for facilitating managing interconnection processes on a power transmission network, in accordance with some embodiments.

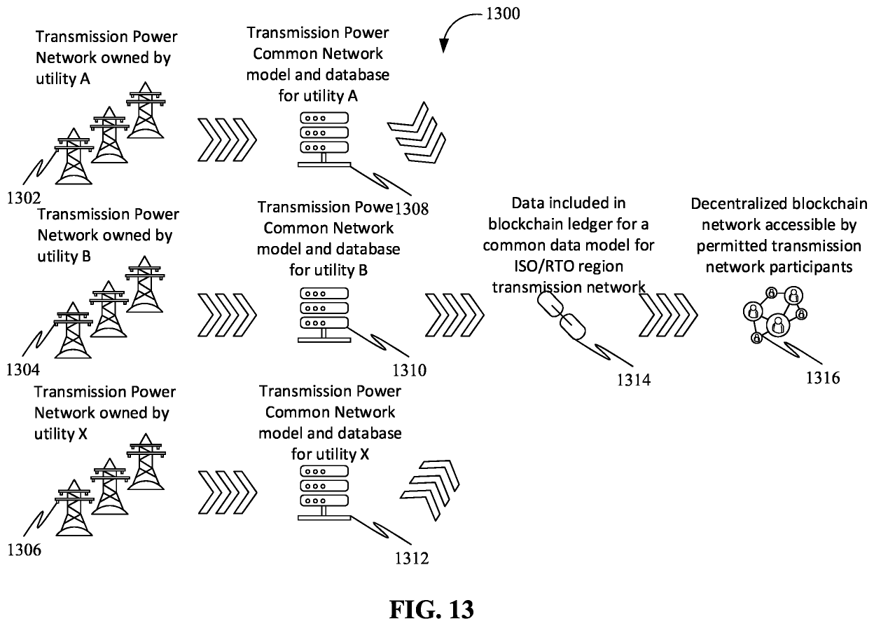

FIG. 13 is a schematic of a system 1300 for creating a common network model and database, in accordance with some embodiments. Further, the system 1300 may include a transmission power network owned by utility A 1302, a transmission power network owned by utility B 1304, and a transmission power network owned by utility X 1306. Further, the system 1300 may include a transmission power common network model and database for utility A 1308, a transmission power common network model and database for utility B 1310, and a transmission power common network model and database for utility X 1312. Further, the system 1300 may include a blockchain ledger 1314 for including data for a common data model for ISO/RTO region transmission network. Further, the system 1300 may include a decentralized blockchain network 1316 accessible by permitted transmission network participants.

Further, a method associated with the system 1300 is divided into two steps: a first one consists of creating a private permissioned blockchain, so a data model of the existing Transmission Power System can be stored and available to all the nodes. Participants in the blockchain shall also be responsible for maintaining and updating the model in the ledger.

The blockchain should be private, due to the criticality of the information (note that currently ISOs/RTOs, following FERC's instructions, require that any stakeholder or market participant who wishes to access to material classified as CEII, needs to have ISO/RTO approval. Participants shall have a security administrator as a point of contact for the ISO's CAMS, which records roles and permissions for each participant: node, a full node, and miners/validators). There are also NERCs CIP standards to follow.

The blockchain should be permissioned, due to the managing role of ISO/RTO. In the future, it could be evaluated if a permissionless blockchain could work, but today the role of ISO/RTO as the main validator of any updates or modifications in the network model shall be maintained as per federal mandate. Other trusted validators could be added to the selected consensus algorithm if considered, like the different Transmission Owners and System Operators.

It shall be a blockchain solution, and not just a cloud centralized database solution dependent on one single organization. The purpose is to make all Utilities, Developers, ISOs/RTOs, SOs, etc. collaborate, rather than compete for resources, and to have a single source of truth, a single distributed database replicated in every node with the information for the Transmission Network model common to every participant, which would optimize the second step of the proposal. The solution should allow to grow in participants and should accelerate the current pace of Interconnection approvals. Blockchain allows participants to request additions to the database as new items (new transmission interconnection projects) or as changes of existing items.

The selection of the consensus algorithm to be used is not that obvious. Existing voting-based consensus algorithms already working in known private permissioned blockchains have been evaluated like PoA (a variant of PoS) or a variant of BFT like FBA or PBFT. FBA algorithm is used in cryptocurrencies like Stellar and Ripple, each with a specific variant. Ripple net is also a centralized and permissioned network using blockchain technology.

For a transmission network data blockchain, a PoA consensus algorithm is proposed. It was created in 2015 and it is based on the identification of nodes and their reputation (Tomic, 2021): nodes do not invest the coins they own, but their own reputation. Nodes that are validators must be known and confirmed by the notary service (ISO/RTO in this case). So essentially it is partially centralized (only a small group of validators can embed blocks), but this is something that can be accepted considering the criticality of the information. PoA is a good fit for a private permissioned blockchain that aims to maintain the information of the transmission power network. Although throughput is low (80 TPS) and scalability is stable (about 8 seconds to validate a block even with more than one thousand nodes in the network), the value of these two characteristics is more than enough for the transmission network blockchain. On the other hand, PoA offers high security (protects the system from Byzantine faults with adversary tolerance<=49%) and requestors and validators are known. Their performance counts toward their reputation, which could be traded later for fees discounts if they present interconnection requests.

Further, the system 1300 may be associated with a Common Network Model and Database with same format for all transmission network participants and merging and unification of all of them in a decentralized blockchain network.

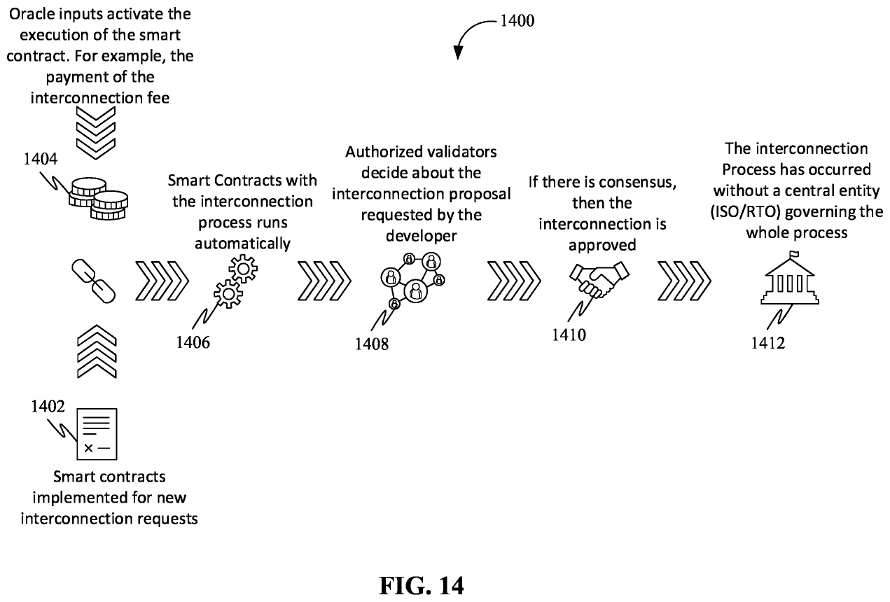

FIG. 14 is a flow diagram of a method 1400 for automatic execution of smart contracts in blockchain for the new transmission network interconnection process, in accordance with some embodiments. Accordingly, the method 1400 may include automatic execution of smart contracts in blockchain for a new transmission network interconnection process using a system (such as the system 900) comprising a database coupled to a query system and a processor. Further, the method 1400 may include a step 1402 of implementing smart contracts for new interconnection requests. Further, the method 1400 may include a step 1404 of activating oracle inputs for the execution of the smart contract. For example, the payment of the interconnection fee. Further, the method 1400 may include a step 1406 of automatically running smart contracts with the interconnection process. Further, the method 1400 may include a step 1408 of deciding about the interconnection proposal requested by the developer by authorized validators. Further, the method 1400 may include a step 1410 of approving the interconnection If there is consensus. Further, the method 1400 may include a step 1412 of performing the interconnection Process without a central entity (ISO/RTO) governing the whole process.

The first step of the method 1400 may include creating a decentralized and secure database with all the necessary transmission power network information and model to be readable by all data network participants and a second step of including the necessary programming and applications on the blockchain to implement Transmission Network Interconnection Processes. FIG. 14 is a representation of the second part of the process, but there can be one single smart contract per interconnection request, or it can be divided into smaller smart contracts, each covering part of the process. Further, the first smart contract can cover the validation of a requestor, the official submission of the interconnection request and the payment of the interconnection fee; the output of this first smart contract could be the moving to the next smart contract and assignment of a queue number; the return of the application to the requestor if deficiencies or lack of payment is detected; or the withdrawal if the requestor decides so during the process. The next smart contract could cover the checking of the technical solution proposed.

A significant difference in the new interconnection process proposed here compared with the current interconnection processes is that the requestor is the one performing the System Reliability Impact Study (SRIS) or SIS, FFS, or LFS for ISO/RTO and others to review and validate. The Requestor shall add the transmission network project in the common transmission network model that needs to be validated by the validating nodes (ISO/RTO, transmission owner/owners impacted, and some other utilities, developers, and owners in the area or with a high performance according to the PoA consensus algorithm).

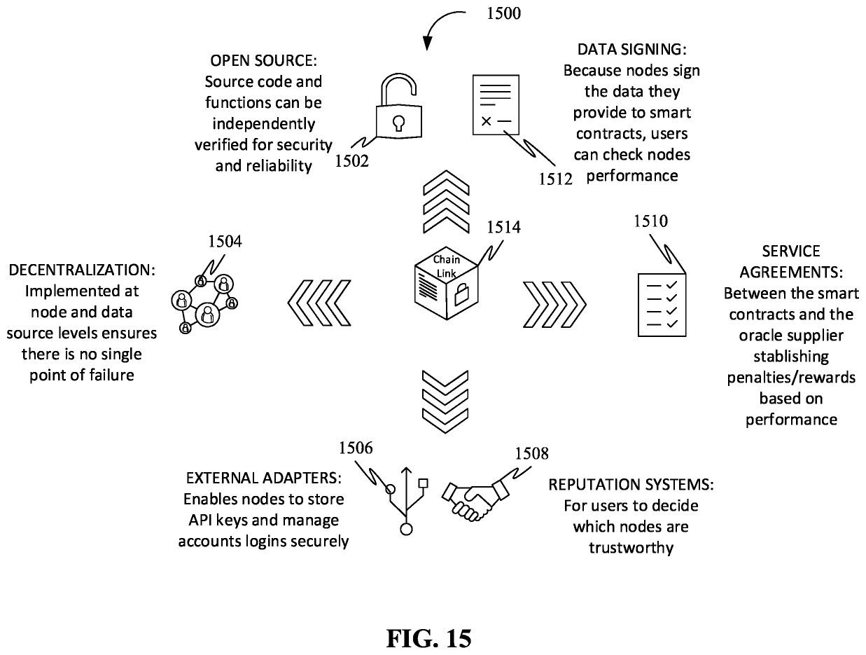

FIG. 15 is a schematic of a system 1500 for facilitating power network interconnection and optimization, in accordance with some embodiments. Accordingly, at 1502, the system 1500 may be associated with an open source code that allows functions of the system 1500 to be independently verified for security and reliability. Further, at 1504, the system 1500 may be implemented at node and data source levels that ensure there is no single point of failure. Further, at 1506, the system 1500 may enable the nodes to store API keys and manage accounts login securely. Further, at 1508, the system 1500 may be associated with reputed systems that allow users to decide which nodes are trustworthy. Further, at 1510, the system 1500 may be associated with a service agreement between a smart contract and an oracle supplier establishing penalties/rewards based on performance. Further, at 1512, the system 1500 may facilitate data signing. Further, the users may check node's performance because the nodes sign the data the users provide to the smart contract. Further, the system (or computer-implemented system) 1500 may house a private permissioned blockchain and a validator processor. Further, at 1514, the system 1500 may be associated with Chainlink that may verify the data from the oracles in a decentralized fashion, so when it is fed to the smart contract, the single point of failure and the threat of unreliable data have already disappeared.

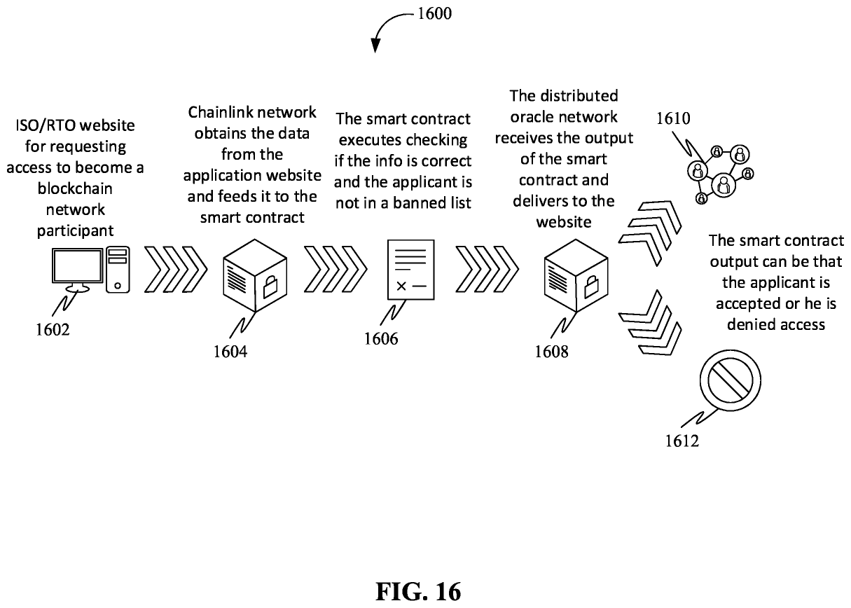

FIG. 16 is a flow diagram of a method 1600 for facilitating a new applicant for requesting access to the blockchain network, in accordance with some embodiments. Further, the method 1600 may include a step 1602 of an ISO/RTO website for requesting access to become a blockchain network participant. Further, the method 1600 may include a step 1604 of chainlink network obtaining the data from the application website and feed it to the smart contract. Further, the method 1600 may include a step 1606 of the smart contract executes checking if the info is correct and the applicant is not on a banned list. Further, the method 1600 may include a step 1608 of the distributed oracle network receiving the output of the smart contract and delivers to the website. Further, the method 1600 may include a step 1610 of accepting of the smart contract output. Further, the method 1600 may include a step 1612 of rejecting of the smart contract output.

The proposed method (such the method 1600) can be summarized as the creation of a private permissioned blockchain network containing an ISO/RTO region's transmission network data model and database that can be read by the nodes/participants connected to the network. Those participants (ISO/RTO, Transmission Owners, System operators, Generators connected to the transmission power network, Loads connected to the transmission power network, Developers willing to get connected to the transmission power network, others . . . ) shall be approved before they can join the blockchain network and that approval process can be implemented with a dedicated smart contract between the ISO/RTO and the new participant willing to get connected. That blockchain data network can be developed based on existing blockchains that support smart contracts, like Ripple, Cardano, Neo, Ethereum, and others. As Ethereum is the dominant one, the recommendation is to start exploring the possibilities of developments in the Ethereum ecosystem like, for example, Quorum, Corda, or Hyperledger Fabric, which are enterprise-ready permissioned blockchain solutions that can be escalated. These already available solutions can be explored, to get ideas, and finally, one can be used or a new blockchain network type can be developed. If an existing blockchain network is selected as convenient enough for the purpose of containing a secure ledger with the transmission. Note that PoW and PoS do not work well with permissioned networks, so a BFT based algorithm is more likely to be implemented in the chosen blockchain network unless it is decided to develop a new blockchain network specifically for this purpose.

Once the blockchain network is implemented and all participants are using it for maintaining and updating the transmission power network, then the next step proposed is the inclusion of smart contracts using the Chainlink network as the off-chain data network provider, so an improved Interconnection Application Process can be implemented.

The essence of the improved Interconnection Process proposed is like the existing ones but taking advantage of the blockchain technology and smart contracts to make it better in many aspects.

Only existing nodes (all of them full nodes) in the blockchain can act as Applicants for a new Interconnection project. So, if the Applicant is a Transmission Owner in the region, it is already an authorized blockchain network participant. However, if the Applicant is a Developer that has no assets connected to the transmission power network, then he can request to be included as a blockchain network participant by filling and providing the necessary information via a specific website owned by the ISO/RTO. This website will have an API to interface with the Chainlink network, so it can extract the data and feed it to a smart contract in the main blockchain network. If the information provided complies with the requirements programmed both in Chainlink and also in the smart contract, then the output of the smart contract can be to accept the addition of a new blockchain network participant or deny it. Assuming the applicant is accepted, then the Interconnection Process can start.

As the entity requesting to go through the interconnection process must be already an existing participant in the blockchain network, and the most updated network model and data are available already in the ledger, then it shall be that same requestor the one proposing an update of the network model and data including its project already connected and the one responsible for preparing the different studies: SRIS, SIS, FFS or LFS.

The Developer must first request a formal interconnection process application. In a similar way, as described in FIG. 16, a smart contract can automatically be executed positively once the Developer requests the interconnection and pays the fees (cryptocurrency payments should be accepted).

If the application is accepted, then there should be a time window in a different smart contract for the Developer to submit the proposed updated network model (new block in the blockchain) and the studies. Note that in this proposal, the Developer is the one performing the studies, not the ISO/RTO.

The ISO/RTO and a few more authorized nodes for validation (Transmission Owner in the POI, System Operator, others . . . ) shall check the feasibility of the new block proposed with the interconnection upgrade. They must have access to the studies prepared by the Developer for performing the validation check of this new block. If consensus is reached according to the implemented consensus algorithm for the blockchain network selected or developed, then the new block is added and broadcasted to the rest of the data network. Studies can be revised in specific programs using APIs via Chainlink, or they can be sent off-chain directly via secure repositories or data messaging services.

Further, as the entity requesting to go through the interconnection process may be already an existing participant in the blockchain network, and a most updated network model and data are available already in the ledger, then the entity may be that same requestor that may be the one proposing an update of the network model data including its project already connected and the one responsible for preparing the different studies: SRIS, SIS, FFS or LFS.

Further, a developer may first request a formal interconnection process application. In a similar way as described in Error! Reference source not found. and anticipated in section Error! Reference source not found., a smart contract may automatically be executed positively once the developer requests the interconnection and pays a fee. Further, cryptocurrency payments may be accepted for the fee. Additionally, if the formal interconnection process application is accepted, then there may be a time window in a different smart contract for the developer to submit a proposed updated network model (or a new block in the blockchain) and the studies. Further, the developer may be performing the studies, not the ISO/RTO.

Additionally, the ISO/RTO and a few more authorized nodes for validation (Transmission Owner in the POI, System Operator, and others) may check the feasibility of the new block proposed with the interconnection upgrade. Further, the ISO/RTO may have access to the studies prepared by the developer for performing the validation check of the new block. If consensus is reached according to the implemented consensus algorithm for the blockchain network selected or developed, then the new block may be added and broadcasted to the rest of the data network. Additionally, the studies may be revised in specific programs using APIs via Chainlink. Further, the studies may be sent off-chain directly via secure repositories or data messaging services.

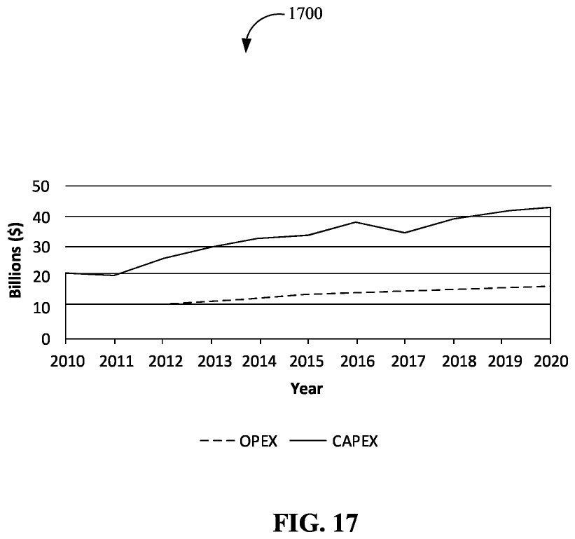

FIG. 17 illustrates a graph 1700 of annual spending on U.S. transmission power network by major utilities between 2010 and 2020. Further, the graph 1700 differentiated CAPEX and OPEX expenses. Further, the maintenance and operating costs (OPEX) have been increasing steadily at a slow pace (from $10 billion in 2010 to $15 billion in 2020) but investments in new projects (CAPEX) have outpaced (from $10 billion in 2010 to more than $25 billion in 2020). During the past decade, according to FERC Financial reports as indicated by EIA (Aniti, 2021), the annual investment in the electric transmission system by major USA utilities (private companies) have increased from around $20 billion to around $40 billion, including both operations and maintenance expenses and new projects investments. Some surveys (LLC, 2021) reveal that around $83 billion of additional transmission investment projects are already approved/recommended from ISOs/RTOs/Utilities for the next decade, without including projects already under construction or those that are in the process but have not been approved yet. Further, taking into consideration the important Paris climate change goal that aims for zero carbon emissions from power generation in 2050, and that electrification in the U.S. is going to continue until and beyond 2050, it makes also sense to estimate how much investment is going to be required annually to achieve this goal. It is also estimated (Dr. Weiss, Hagerty, & Castaner, 2019) that governmental policies are also going to incentivize utilities and developers to invest in transmission projects to achieve those goals at least until 2050. Therefore, considering at least these driving forces (there are more, but these are the most powerful and obvious ones), there have been different estimates on how much it would be required to invest annually in the transmission power system in the incoming years until 2050. One of such estimates (Dr. Weiss, Hagerty, & Castaner, 2019) concludes that around $40 billion invested annually in new Transmission Projects will be required between 2030 and 2050 to achieve the goals previously mentioned. This amount includes the normal projected investment without considering the goals (around $20-25 billion annually for just usual transmission projects investment like interconnection of renewable generation to satisfy existing load or other projects to increase reliability, security, and resilience of the transmission network) and an estimate of $20-25 billion dollars of additional investment annually (specifically derived from the driving forces described above).

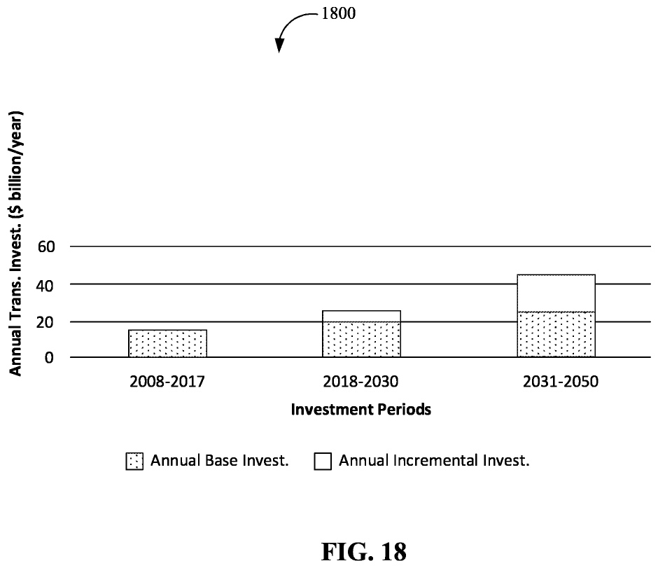

FIG. 18 illustrates a graph 1800 of base and incremental annual transmission project investments. Further, the graph 1800 illustrates annual transmission investment (base & Incremental—due to driving forces) until 2050 (CAPEX). Further, base and incremental annual transmission project investments due to climate change goals, reduction of fossil fuel-based generation, an increase of renewable generation, and favorable policies, among others, until 2050. Further, the graph 1800 shows the significant impact of new interconnection investments in the current period until 2030 (additional $5 billion CAPEX) but more importantly the estimate between 2031 and 2050 (additional $20 billion CAPEX). Further, the tendency on investments in operations and maintenance on transmission power networks is going to continue rising, and also in usual projects in order to replace aging facilities, increase reliability, security, and resilience of the Network, and to connect renewable generation; but there is also a considerable amount of investments (around 50% of the total for the period 2030 to 2050) expected for the Transmission Power Network as the consequence of some important driving forces (Paris carbon goal, electrification, technology, and policies). This increase in investments highlights the importance of an optimal procedure to manage the current transmission network information and to process new interconnection requests.

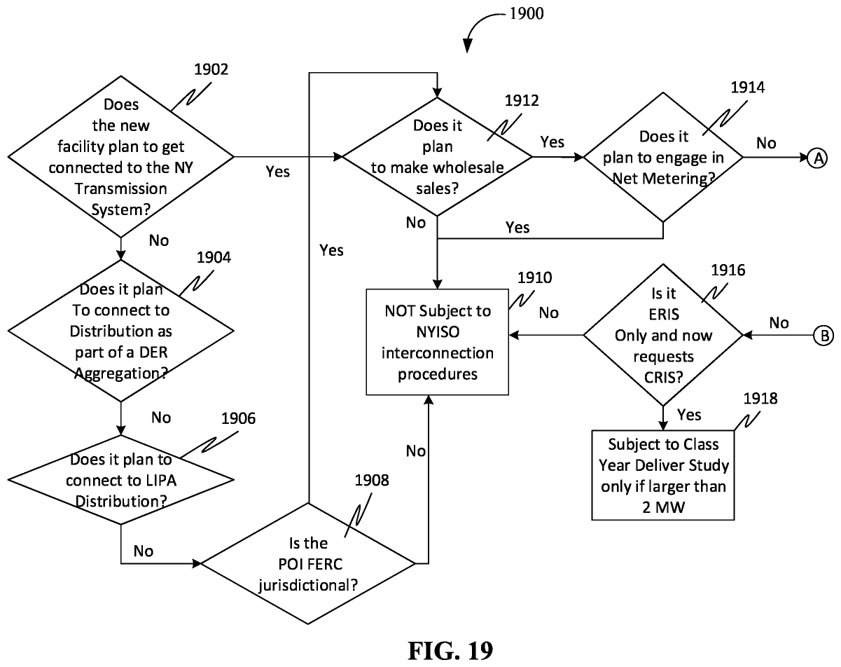

FIG. 19 is a flowchart of a process 1900 for NYISO large facilities interconnection qualification. Further, the process 1900 starts with a step 1902 of deciding to do the new facility plan to get connected to the NY transmission system. If not, the process 1900 continues to a step 1904 of deciding does it plan to connect to distribution as part of a DER aggregation. If not, the process 1900 continues to a step 1906 of deciding does it plan to connect to LIPA distribution. If not, the process 1900 continues to a step of 1908 of deciding is the POI FERC jurisdictional. If not, the process 1900 continues to a step of 1910 of NOT subject to NYISO interconnection procedures. After the step 1902, if yes, the process 1900 continues to a step 1912 of deciding does it plan to make wholesale sales. If yes, the process 1900 continues to a step 1914 of deciding does it plan to engage in Net Metering. If not, the process 1900 continues to a step 1920 of deciding is it an existing facility and has a PPA or IA with its interconnection rights. If yes, the process 1900 continues to a step 1922 deciding is it materially increasing its output or making a material modification. If yes, the process 1900 continues to a step 1924 of deciding is total output greater than 20 MW. If yes, the process 1900 a step 1926 of subjecting to LFIP. If not, the process 1900 continues to a step 1928 of SGIP. After the step 1908, if yes, the process 1900 continues to the step 1912. After the step 1912, if not, the process 1900 continues to the step 1910. After the step 1914, if yes, the process 1900 continues to the step 1910. After the step 1922, if no, the process 1900 continues to a step of 1916 of deciding is it ERIS only and now requests CRIS, if no the process 1900 continues to the step 1910, if yes the process 1900 continues to a step 1918 of subjecting to class year deliver study only if larger than 2 MW.

Further, transmission interconnection processes are processes followed by a developer, transmission owner, generator, or load owner in the U.S. when they want to connect a new facility to the transmission power network. Further, these processes are put in the place by the ISO/RTO operating in the area where the POI is going to be. Each ISO/RTO has its own processes, but they are alike. Other entities that are usually involved in the process are the transmission owner the new facility is going to be connected to (could be more than one), the system operator, and other generator owners that could be impacted. Further, transmission interconnection processes refer mostly to specific ISO-NE and NYISO interconnection processes, and it can be extended to all other ISO/RTOs in North America. Also, in order not to get lost in many different scenarios, a qualifying review specific for large facility generators (more than 20 MW) interconnection process for NYISO is introduced next. First, in order to identify if the new proposed facility to be interconnected is subject to NYISO Interconnection Procedures. Once the new generating or transmission facility is identified as subject to the NYISO LFIP, then the specific process shall be followed. Current Interconnection Processes, independent of the particular ISO/RTO and requesting facility, have the following disadvantages:

a) It is controlled and governed by the ISO/RTO: not only their Process must be followed, but they participate, perform the necessary studies based on the data and models provided and finally they evaluate and decide whether to approve it or not. So, it could be said that the interconnection process is a Centralized Process where the ISO/RTO is the Central authority.

b) It is a time-consuming process: These are long processes with several stages (identification and authentication of the requestor, initial submission of interconnection request, scooping meeting, studies preparation, fees payment, commercial discussions, etc.). The Studies phase is usually the longest one, and just the SIS takes an average of six to ten months.

c) Iterative Process: Once the Interconnection Request is submitted, the ISO/RTO may consider it invalid or deficient, a time window is opened for the Developer to correct it. Same once ISO/RTO reviews and analyzes the data submitted with the request. ISO/RTO may request modifications to the request if they consider after evaluation, for the Requestor to agree. All these modifications add time to the process and may require several iterations until all parties agree.

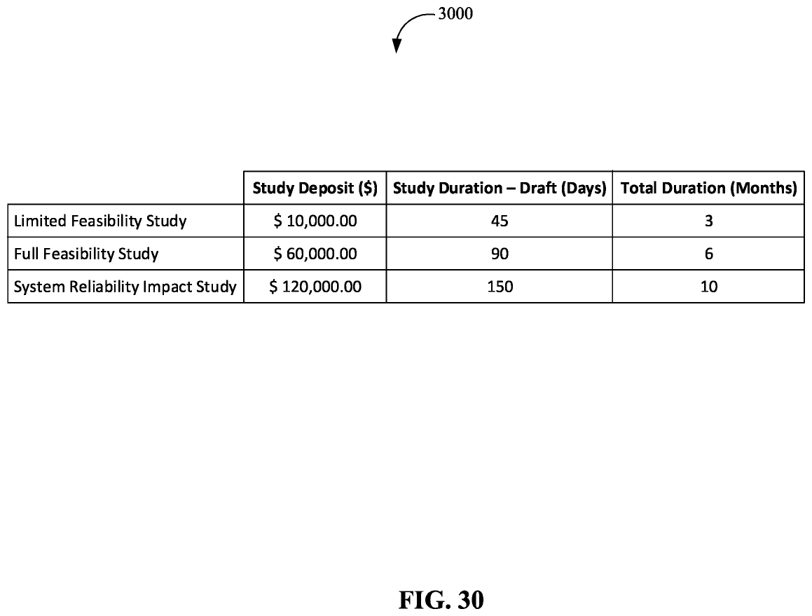

d) It is an expensive Process: There is an initial non-refundable fee just for the interconnection request. After that, for each type of Study to be performed, there are additional fee deposits (as shown in FIG. 30) that range between $10,000 and $120,000 each for the case of NYISO, depending on the type and complexity of the study.

e) Lack of visibility during the process: ISO/RTO puts together the complete model of the Transmission Network with the partial model of the new facility supplied by the Developer. However, the Developer does not have the model available and cannot see or check how the study is going until the Draft study is finalized. Only then the ISO/RTO may share the complete network data model (PSSE format) for the Developer to check it and perform additional studies on its own. If results show that Transmission Network upgrades are required as a consequence of a future interconnection of this new facility, the Developer would need to take responsibility for those updates and he would not have confirmation until the Draft is released by ISO/RTO.

f) These are FIFO Processes: Once the Interconnection request is submitted and a queue number is assigned, the ISO/RTO considers the projects in the queue in their models for the studies in chronological order. This procedure may look fair but prevents network optimization. If an Interconnection project higher situated in the queue withdraws, it can have an impact on all those projects below in the queue, and sometimes the impact could be high enough (in time and cost as scope changes) to make the project not financially viable anymore, which could lead to another withdrawal.

g) Different Transmission Network Data Models: ISOs and RTOs, as responsible entities for the reliability of the Power Network in their region, maintain and work with their own network data model, which is the one they use for the studies in the Interconnection Processes. This model is updated with the information that all other transmission network participants feed them. If all network participants could work with the same complete network data model, assuring security and integrity of the information, significant synergies could be achieved, and the market could move from a competitive approach to a more collaborative approach. This approach would save time and money.

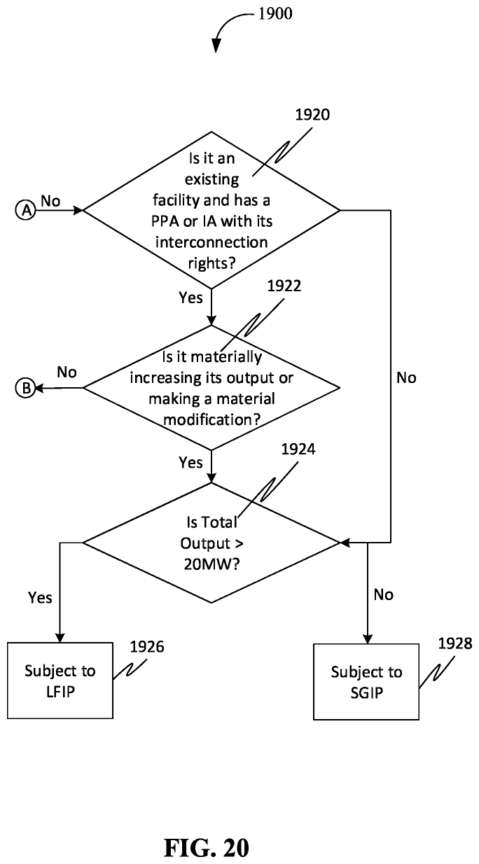

FIG. 20 is a continuation flowchart of the process 1900 for the NYISO large facilities interconnection qualification.

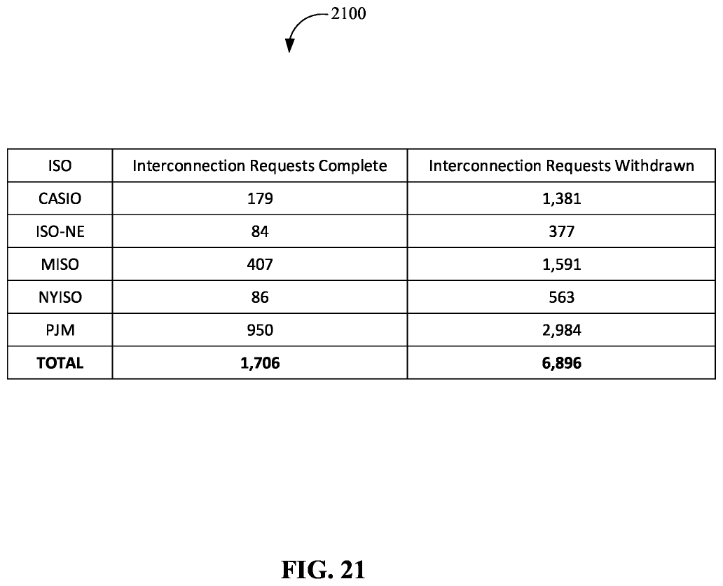

FIG. 21 illustrates a table 2100 of completed and withdrawn interconnection projects in the U.S. Further, the table 2100 may be according to data from 5 ISOs. Further, the table 2100 indicates that approximately the number of interconnection requests withdrawn is 4 times greater than the number of interconnection requests completed (Joseph Rand, 2021). This study was performed with projects in transmission interconnection queues of 5 ISOs through the end of 2020. It shall also be noted that not all projects with the interconnection process completed are ultimately built and connected to the transmission network, so the final number of real projects interconnected are even lower than shown in the table 2100. It should also be noted that some projects, in order to save time and find an optimal interconnection, may request more than one interconnection process. This strategy is costlier, as they must pay the fees for every request and for each requested study but allows the Requestor to save time.

If they wait until the first request is completed before requesting an alternative interconnection point or conditions, some other requests may appear in the queue and the time for the second interconnection request to be completed could be delayed for much longer than what the project can withstand.

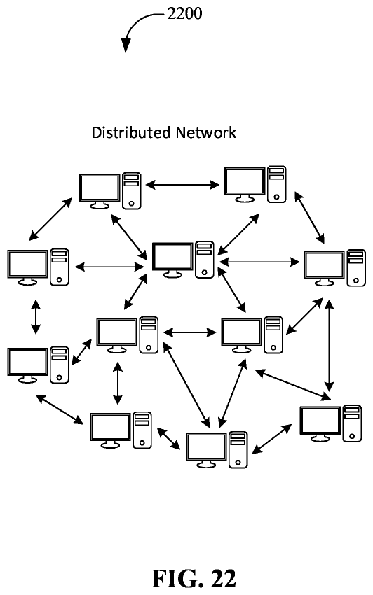

FIG. 22 illustrates an architecture of a decentralized network 2200. Further, the decentralized network 2200 is associated with Blockchain technology. Blockchain is an emerging technology that has been experiencing very rapid evolution and gaining significant attention during the last decade (Johannes Sedlmeir, 2020). From a technical perspective, it can be considered a set of protocols, algorithms, and encryption techniques that, when combined, allow to store data in a secure manner in a distributed communications network. On a more general definition, it is a technology that allows individuals around the world to interact in a trusted and distributed peer-to-peer network without the need for centralized management. According to (Gupta, 2020), blockchain is a shared, immutable ledger that facilitates the process of recording transactions and tracking assets in a business network. This definition fits perfectly to the Interconnection processes if the transactions are referred to as interconnection requests and studies and the tracking assets to a common transmission power network model. According to (Drescher, 2017), a first provisional and incomplete definition for blockchain is: “a purely distributed peer-to-peer system of ledgers that utilizes a software unit that consists of an algorithm, which negotiates the informational content of ordered and connected blocks of data together with cryptographic and security technologies in order to achieve and maintain its integrity”. Integrity and trust are key components in this definition as usually every money, data, or asset transaction is done today via a centralized body that is in charge of those two aspects.

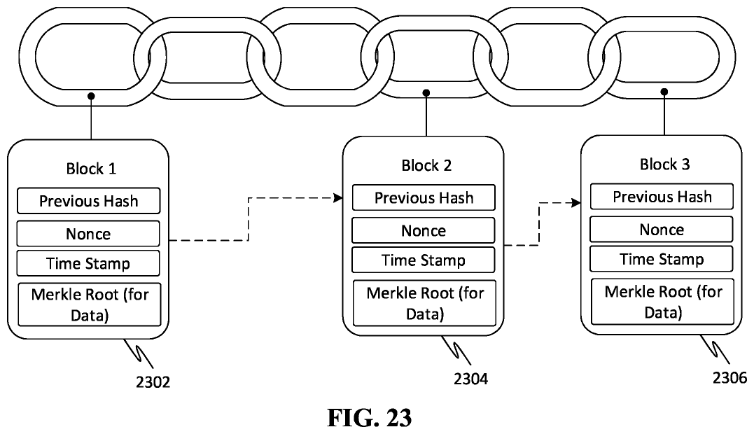

FIG. 23 illustrates components of blocks 2302-2306 in the Blockchain. Blockchain technology could be simplistically be defined as a distributed secure Database or distributed ledger. Further, the blocks 2302-2306 may include three blocks 2302-2306 in the blockchain. Each block after the first is linked to the previous block via the hash The Database is made up of different blocks 2302-2306 of data, each one encrypted and assigned a code called hash, which links each block of data with their predecessors. Blockchain combines cryptography with distributed computing. Compared with common companies like Youtube or Facebook which have centralized databases in huge capacity servers, the disruptive concept of Blockchain technology is that there is no need for a centralized entity and computers in the network collaborate to maintain a distributed (each one of them has a copy of the blockchain), trusted and secure database. The first and most prominent application of blockchain technology is the management of ownership of crypto-currencies, a new type of digital currency, being BTC the first crypto-currency that was proposed in a white paper in 2008. However, other blockchain technologies like Ethereum allow the inclusion in the blockchain of distributed applications, capable of executing any type of computer coding in the blockchain, being distributed smart contracts a key component for expansion and adoption of blockchain. Numerous other protocols, algorithms, and blockchain-based applications have emerged since then, usually with a token of their own, and the tendency continues to grow. This rapid growth of blockchain is due to the potential benefits of those characteristics and their application to numerous sectors including the energy sector. As there is no centralized entity in charge, to verify and validate modifications to the ledger it is necessary a distributed consensus algorithm, so no single computer/node can alter the data in the blockchain without the consensus of most of the rest of the computers. If the majority agree, the new block is added to the blockchain in chronological order. Different consensus algorithms are available today for any new blockchain. BTC uses Proof of Work (PoW); Ethereum is expected to move from PoW to Proof of Stake (PoS) by the end of 2021; and there are others like PoA, PBFT, etc.

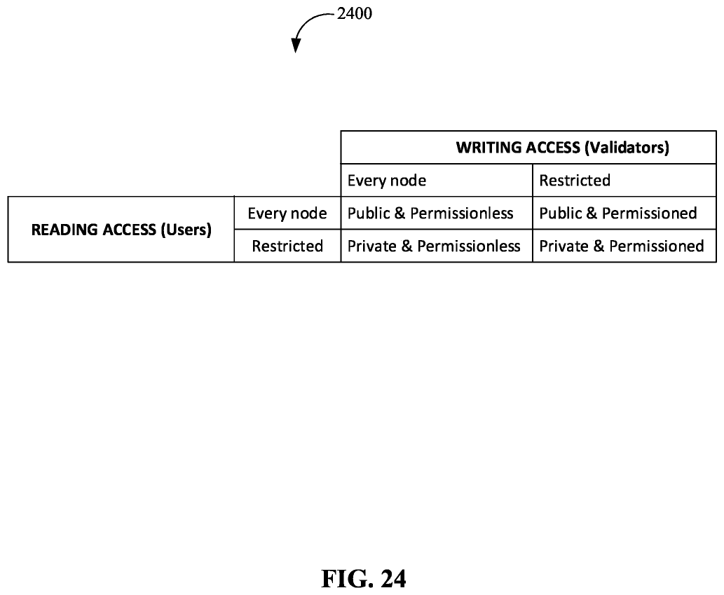

FIG. 24 is a table 2400 illustrating four types of Blockchain. As it is very well explained in (Drescher, 2017), four types of Blockchain can be identified attending reading and writing access to the blockchain. Deciding who can have reading access is equivalent to deciding the level of transparency versus privacy desired. A high degree of transparency allows every node/computer in the network to have reading access and rights to create new transactions (public blockchain), while a high degree of privacy limits the reading access and right to create new transactions (private blockchain). Deciding who can have writing access (nodes can verify transactions and add new blocks to the blockchain) is equivalent to deciding the degree between security and speed. In the case of the interconnection process, this would be the regulator. A permissionless blockchain lets every node add blocks, so it is fast but could be considered less secure. Permissioned blockchains only let some preauthorized and trusted nodes add blocks, increasing security but reducing speed for transactions. Pure distributed systems aim to be fully public and permissionless. Restricting reading and/or writing access introduces some non-purely distributed authority that decides which nodes can read or write in the blockchain. However, in some cases (depending on the importance of transparency, privacy, security, and speed), it might be preferable to sacrifice the purely distributed nature of the blockchain to guarantee higher security or privacy. Hybrid solutions are possible as well: blockchain architectures that can be considered partly public and partly private. As explained in (Merlinda Andoni, 2018), other classifications for blockchains are general purpose vs specific purpose blockchain (the most immediate example is BTC—specific purpose for currency transactions—and Ethereum—general purpose where many different applications can be developed); and Open Source vs Closed Source blockchain (Open source blockchains are open to every node to make decisions about the blockchain in a transparent way; in a closed source blockchain, only a few nodes can make decisions about how to manage the blockchain, so it is a more centralized solution).

3.3 Types of Distributed Consensus Algorithms The Consensus algorithm used to decide whether a new transaction or data to be added to the blockchain in a new block is valid impacts on different characteristics as speed, level of trust, scalability, security, and consumption of resources.

Assuming a public and permissionless system, any node can propose the addition of a new block with data/transactions to the blockchain. Whether that block is generally accepted as valid to be added to the blockchain or not, depends on the rules of the consensus algorithm used. The closer a blockchain is to a public and permissionless system, the more critical the consensus algorithm becomes, as it makes it possible that any node in the network can trust the activity of other nodes without knowing them. On the other hand, the more private and permissioned the blockchain is, the lesser the need for a distributed consensus algorithm—as there is some degree of centralization—and the faster the system is.

There are many distributed consensus algorithms, with different characteristics. All of them must contemplate the process of creating a block, proposing it to be added to the blockchain, reaching a consensus that the block is accepted, and validating the new block so it becomes permanent in the blockchain (Merlinda Andoni, 2018).

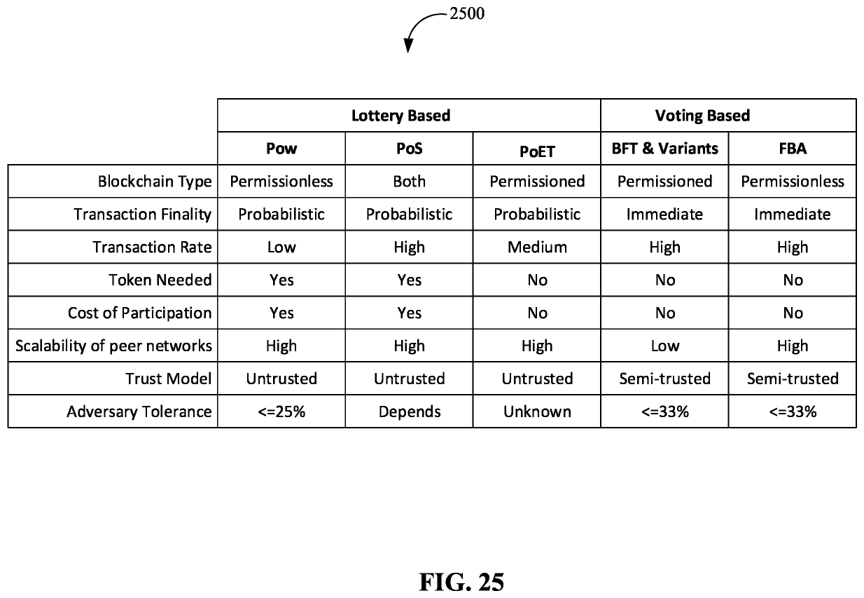

FIG. 25 is a table 2500 illustrating some characteristics of main distributed consensus algorithms. A broad classification of the different distributed consensus algorithms as suggested in (Hiperledger Architecture Working Group, 2017), contemplates two types: Lottery based and Voting based consensus algorithms.

Lottery based consensus algorithms include PoW (used in BTC), where the nodes who solve a cryptographic puzzle—that is the work—first validate and propose the new block for other nodes to verify, and it gets rewarded in BTC; PoS. where validators are selected randomly, and their vote weight is proportional to their stake size; PoET, where a random elapsed time is generated which decides which node wins a block, minimizing energy consumption compared with PoW; and others.

Voting-based consensus algorithms include BFT and variants, including FBA. The Byzantine General's Problem was initially conceived in 1982. Disperse Generals attacking a common enemy must agree on a coordinated attack, assuming there might be some disloyal Generals and that messages may get delayed, lost, or intercepted by the enemy. BFT and many variants are able to continue operating even if some nodes are malicious or fail. PBFT provides immediate finality, but if the network grows too big, there might be impacts on speed and scalability as messaging traffic increases too.

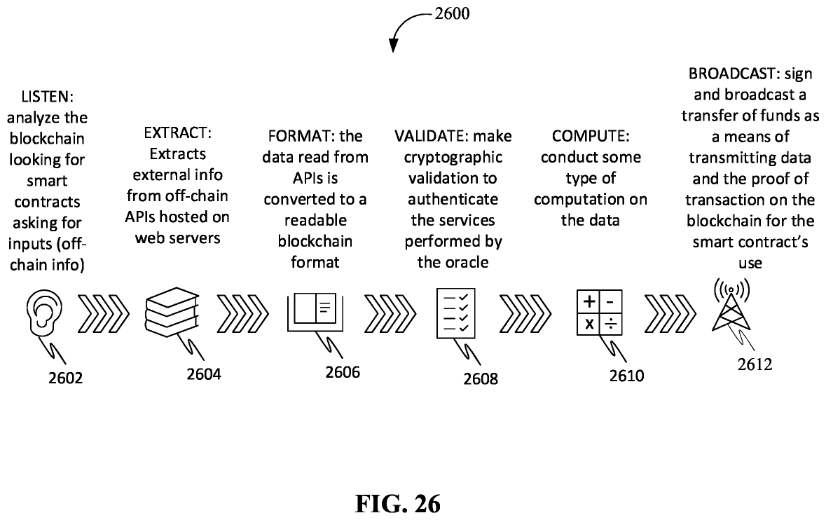

FIG. 26 is a flow diagram of a method 2600 for illustrating the working of blockchain oracles. Further, the method 2600 may include a step 2602 of analyzing the blockchain looking for smart contracts asking for inputs (off-chain info). Further, the method 2600 may include a step 2604 of extracting external info from off-chain APIs hosted on web servers. Further, the method 2600 may include a step 2606 of converting the data read from APIs to a readable blockchain format. Further, the method 2600 may include a step 2608 of making cryptographic validation to authenticate the services performed by the oracle. Further, the method 2600 may include a step 2610 of conducting some type of computation on the data. Further, the method 2600 may include a step 2612 of signing and broadcasting a transfer of funds as a means of transmitting data and the proof of transaction on the blockchain for the smart contract's use.

Further, immutable automatically executed agreements such as smart contracts exist in a blockchain. Smart Contracts are self-executing business automation applications that run on a decentralized network such as blockchain (Mearian, 2019).

As previously commented, BTC was the first cryptocurrency created, which consists of a database of immutable transactions. However, the creation of Ethereum, considered the second generation of blockchain, allowed the development of applications inside of the blockchain. One of the most promising and useful applications is smart contracts, computer coding containing contractual agreements which are self-executing. Compared with traditional contracts, smart contracts remove the need for trust in the other parties or in a centralized organization enforcing the fulfillment of the contract. This is possible because these smart contracts, once in the blockchain, cannot be altered and they activate automatically when the input conditions are met (Tech, 2018). Because the smart contracts are programing code included in the blockchain, they are immutable, and therefore it is trusted by the parties that they are going to be executed as soon as the necessary conditions to trigger the activation of the smart contract are met. No one can manipulate the contract.

Smart Contracts are used today in many different fields. Some examples are the healthcare (information about patients can activate request of hospital supplies and medicines, for example); supply chain (to manage inventory and automation of different tasks and payments to providers); or financial services (insurance payments, for example, previous check and confirmation) (Corporate Finance Institute, 2015). Many other applications are surging, and the numbers keep growing: Digital Identity, IoT, Real Estate transactions, Taxes, etc. (Ambisafe, 2020). Further, the smart contracts do not explain how data is fed to the smart contracts for them to execute. Smart Contracts are reliable because they cannot be changed as they are coded in the blockchain, but the data used as inputs need to be as reliable for users to trust the output of the smart contracts algorithms. Blockchains cannot use data from outside their network. Therefore, it is needed a reliable and trusted way of feeding data to the system. This can be done using Oracles, which are interfaces between an external data server or provider and the blockchain, feeding data into the network (Tech, 2018). The external data they provide can be used to trigger the smart contracts for them to execute. Oracles can be seen as agents that gather info from the external world and feed that data to the blockchain. But oracles are third-party services, meaning that they are not part of the blockchain. This creates what is called the Blockchain Oracle Problem (Takyar, 2021): the trust, authenticity, and security issues among the trustless smart contracts executions and the third-party oracles. Oracles are not distributed, so they become a single point of failure, which blockchain was trying to avoid when moving from a centralized ledger to a distributed one. Also, even if the Oracle can be trusted, the off-chain data it is feeding to the blockchain may be corrupted or false.

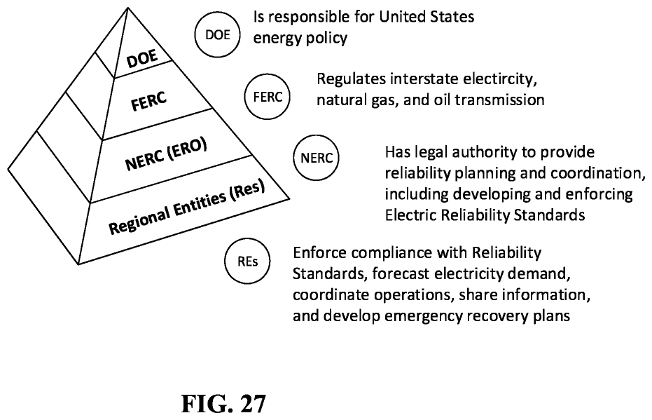

FIG. 27 illustrates electricity market regulation bodies in the U.S and the roles played by the electricity market regulation bodies. Further, the electricity market regulation bodies operate under Power Grid regulation in the U.S. Further, the transmission of Power works as a regulated monopoly under cost-of-service or incentive-based arrangements in the U.S. (Pedro Linares, 2013). Regulators in the U.S. have been developing new rules to encourage competition and avoid vertically integrated monopolies for utilities. However, since the transmission power network is a natural monopoly, the U.S., like other countries, started enacting rules to unbundle certain activities of existing vertically integrated utilities acting as monopolies to encourage competition (generation of electricity, retail of electricity . . . ) in the 70s and the 80s (Pedro Linares, 2013).

The bodies or organizations responsible for the power system regulation and policies in the U.S. are found at the National or Federal Level, Multi-State Level, and State Level. At the Federal level, there is the Federal Energy Regulatory Commission (FERC), which regulates interstate electricity commerce (transfer of electricity between different States), as established in the Department of Energy (DOE) Organization Act of 1977.

FERC issued Orders 888 “Promoting Wholesale Competition Through Open Access Non-discriminatory Transmission Services by Public Utilities; Recovery of Stranded Costs by Public Utilities and Transmitting Utilities.” and Order No. 889 “added and amended existing rules” in 1996, that changed the electricity market via restructuration and liberalization: it moved from existing monopolies hold by vertically integrated power utility companies and allowed substantial deregulation of the electric industry. The two key elements in order 888 were the acknowledgment that there will be constraints in a new competitive wholesale market—and initiatives appeared to create Independent System Operators (ISO) to deal with those constraints—and that if vertically integrated monopolistic companies had to allow access to their transmission networks to transport electricity generated by third parties, then those companies should be compensated and a Cost of Service be paid to them. These Orders changed the wholesale energy trade market from bilateral transactions and power pool agreements to a competitive open market under the supervision of the ISOs initially made up of groups of transmission power network owners (FERC, 2020).

In 1999 FERC issued Order No 2000 establishing Regional Transmission Organizations (RTOs). This Order encouraged electric utilities to become members of RTOs, and it also requested RTOs to implement real-time generation-load balancing, which promotes the connection of renewable generation.

There is another entity at the Federal Level called North American Electric Reliability Corporation (NERC) which is was founded in 1968 with the mission of improving the reliability and security of the Bulk-Power System in the United States, Canada, and part of Mexico. NERC is certified by FERC and it prepares and issues reliability standards as per FERC requirements and enforces their compliance.

In summary, the main bodies today responsible for regulating the Power Grid in the U.S. (both transmission and distribution) are (Office, 2015):
FERC: it is an independent agency belonging to DoE that regulates the interstate transmission and wholesale sales of electricity in the U.S., and it has the authority to enforce regulations concerning the reliable availability of energy resources.
NERC: it is a non-for-profit international regulatory authority to ensure the reliability of the bulk power system in North America. Since 2006, NERC was appointed by FERC as the government's ERO, with the power to oversee and regulate the electrical market according to certain reliability standards.
ISOs/RTOs: FERC recommends the creation of RTOs/ISOs. ISOs operate their regional electricity grid, administer their region's wholesale electricity market and provide reliability planning for the region's bulk power system. RTOs, in addition to those functions, also coordinate, control, and monitor the operation of the power grid in their region. In this proposal, the ISO/RTO is the regulator of the blockchain with the transmission network data model.

At an inter-state level, RTOs and ISOs have already been mentioned. They perform the same functions: operate the electricity grid in an area—a State or several States—, manage the wholesale electricity market in that area and are responsible for the planning of the generation and transmission network for reliability purposes. The difference is that RTOs are designated by FERC as a result of Order No. 2000 whereas ISOs appeared as a recommendation of FERC's Order No. 888.

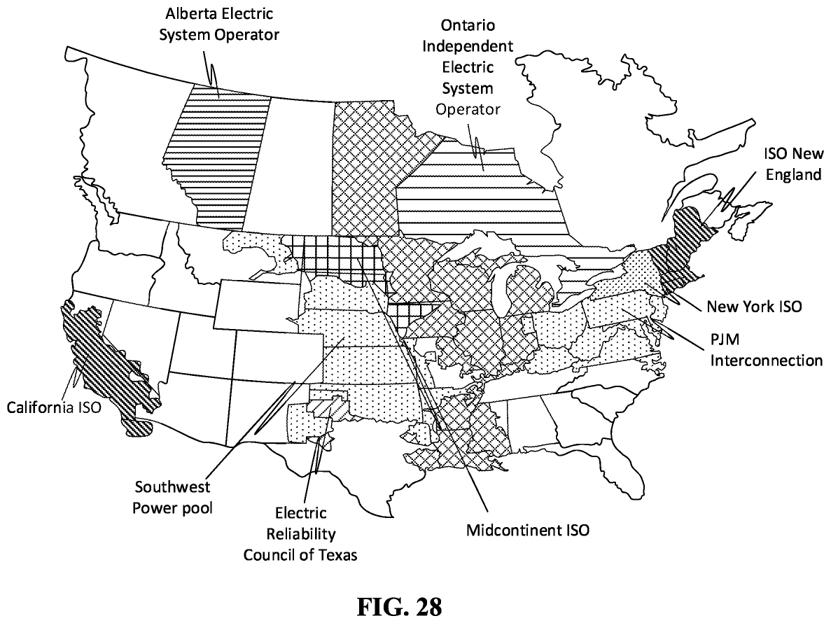

FIG. 28 illustrates 9 ISOs/RTOs in the U.S. and regions of the 9 ISOs/RTOs. There are currently nine RTOs/ISOs serving two thirds of electricity customers in the U.S. and more than one half of Canada's population, according to ISO/RTO Council. The remaining areas/customers/population are managed by power utilities, federal administrations, cooperatives, etc. Further, the 9 ISOs/RTOs may include Alberta Electric System Operator, Ontario Independent Electric System Operator, ISO New England, New York ISO, PJM Interconnection, Midcontinent ISO, Electric Reliability Council of Texas, Southwest Power pool, and California ISO.

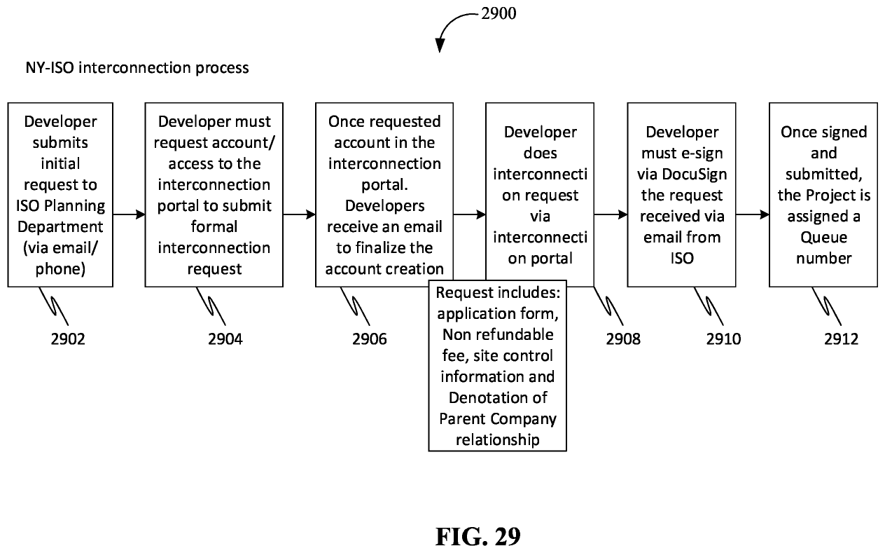

FIG. 29 is a flow diagram of a method 2900 of first steps of the NYISO interconnection process. Further, the method 2900 may include a step 2902 of submitting an initial request by the developer to ISO Planning Department (via email/phone). Further, the method 2900 may include a step 2904 of requesting account/access to the interconnection portal to submit a formal interconnection request by the developer. Further, the method 2900 may include a step 2906 of receiving an email to finalize the account creation by the developer once the requested account is in the interconnection portal. Further, the method 2900 may include a step 2908 of the developer doing interconnection requests via the interconnection portal. Further, the method 2900 may include a step 2910 of the developer e-signing via DocuSign the request received via email from ISO. Further, the method 2900 may include a step 2912 of assigning the project a queue number once it is signed and submitted. Further, the request includes application form, non-refundable fee, site control information, and denotation of a parent company relationship.

Further, the NYISO interconnection process is an interconnection process for a Utility today in NY State Although the Transmission Network Interconnection Processes in the U.S.

Usually, a Developer makes its internal evaluation and decides to pursue a new transmission project, as a response to a public call for proposals for new projects, as a result of the area ISO/RTO identifying the need of new projects, as result of an own initiative or because of any other reason. Note that Transmission Network Projects are significantly expensive projects compared with distribution projects (to give an idea, a normal order of magnitude is nine figures—hundreds of million U.S. dollars) and have an execution timeline of several years.

FIG. 30 is a table 3000 illustrating the NYISO interconnection process fess. A significant amount of that time is consumed by the permitting process and the interconnection process, and the Developer owns the risk of the uncertainty about how long the process is going to take. Error! Reference source not found. provides the rates and average time just for the studies during the interconnection process:

Before getting the ISO/RTO to perform a study, first, the Developer must follow the steps as shown in FIG. 29. The Developer must access/create an account for identification purposes, which can be used as a mechanism for verification and authentication of the Developer later during the process.

Once the Developer is logged in the NYISO Interconnection Portal and the account is approved, the Developer uploads all necessary information and the project gets a number assigned to the ISO/RTO queue of projects to be interconnected. At that time, a period starts for ISO/RTO to review the interconnection request information provided. If ISO/RTO considers there are deficiencies in the application, the ISO/RTO informs the Developer and he has a limited time to correct those deficiencies or the project is withdrawn.

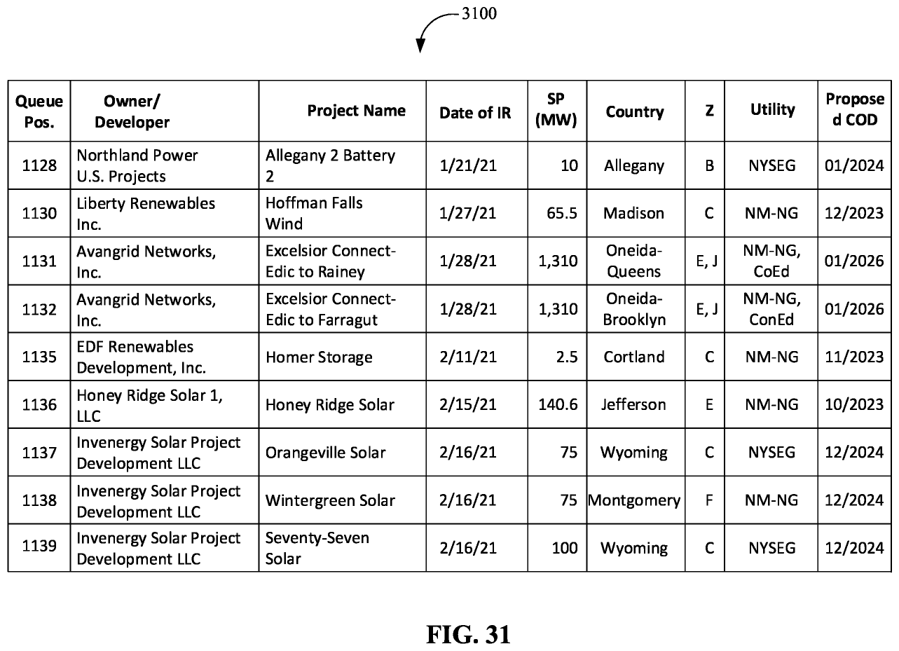

FIG. 31 is a table 3100 illustrating extract from the NYISO interconnection queue. Once ISO/RTO considers the application is valid in form, the project interconnection request is accepted and added to the Interconnection Queue and then they technically evaluate the interconnection application and check the payment of the fees. If there are deficiencies again, the Developer shall correct them. Once ISO/RTO fully validates the interconnection request in form and content, a scoping meeting is scheduled within 30 days. During that meeting, it can be decided that the scope shall change, or alternative solutions should be pursued. The Developer must decide which studies he wants to proceed with too. It makes sense to go with the SRIS/SIS study to reduce the risk of identifying the need for upgrades in the scope once the project is more advanced. However, this is the most expensive and time-consuming study and the results may show that changes in the scope are required anyway; but it would be known then. Once the studies are performed and the scope of the project is updated if necessary, then there is a final performance confirmation from the ISO/RTO to make sure the facility constructed behaves as requested in the studies, before it can be connected to the Transmission Network.

With the intention to save time and reduce the risk of changes on the scope of the project, the Developer's transmission planning team usually performs the ISO/RTO studies in advance by themselves, with the Transmission Network model they own. However, as the model used is not the exact one the ISO/RTO has, the results obtained by the Developer may not match the ones from ISO/RTO, although they can provide a first estimate of what might be required.

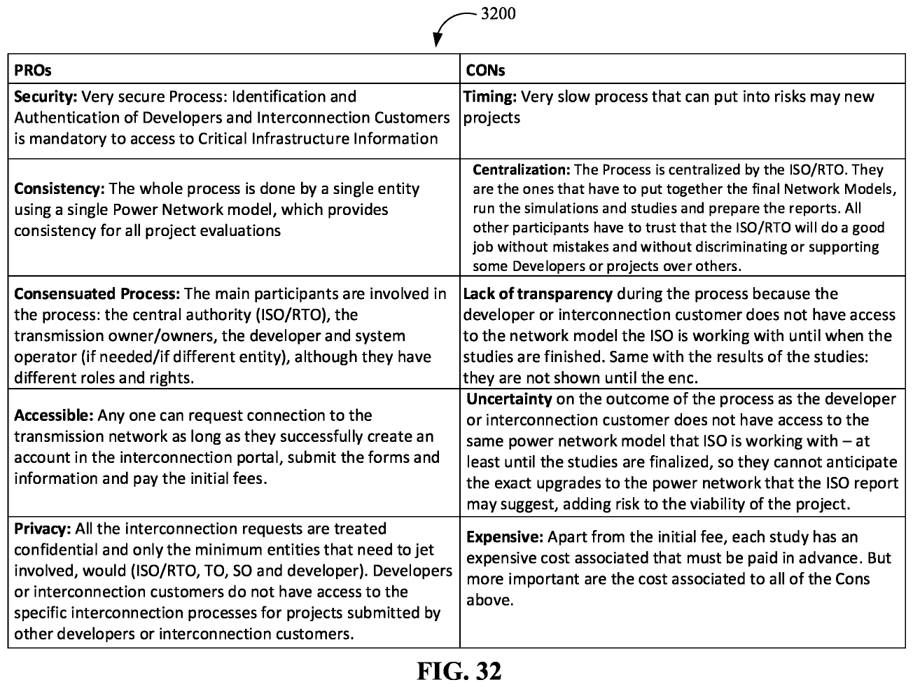

FIG. 32 is a table 3200 illustrating pros and cons of the current ISO interconnection process. Up to this point, a high-level description of the transmission interconnection process has been provided.

The main reason for having the interconnection process Centralized is precisely in order to achieve the advantage of Consistency. Today, utilities, transmission owners, and owners of facilities connected to the transmission power network must send updated models and data of their transmission assets to their ISO/RTO, so they can have a complete model of the power network in their region. If all of these transmission owners and participants had a common way of modeling the transmission power network data for their entire organizations, and that common way was the same for all the participants, and all of them could have a local copy of the entire region's network that updates itself and all other copies available, a lot of effort, time, redundancies, mistakes, etc. could be saved and a single organization (ISO/RTO) would not be necessary anymore as entity centralizing the complete model of the transmission network. Every participant could update immediately its part of the transmission network model in its own database and soon after, once the change is validated, all other databases belonging to all other transmission network participants would be updated as well with the new information, and with a record of when it was changed, what were the changes, who proposed them and who validated them. If such a data communication network could be implemented for each of the transmission power network participants and future ones, then we have the structure necessary for changing the Transmission Network Interconnection Processes as they are today. The change would be appealing if it can maintain the advantages mentioned in the table 3200, while removing the disadvantages also mentioned, and if more advantages can be guaranteed.

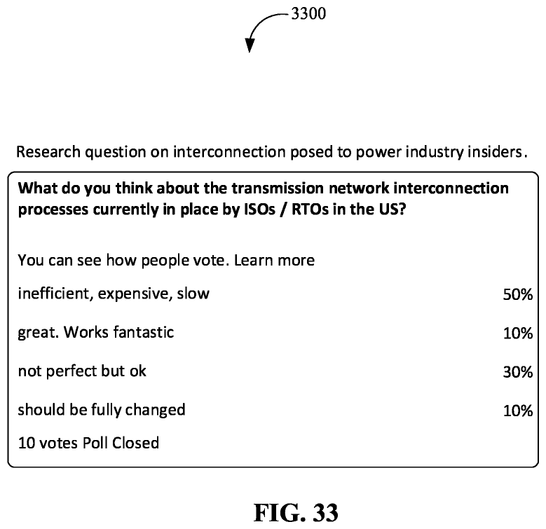

FIG. 33 illustrates one of the polls 3300 directed to interconnection processes experts in an internet professional network. Further, the polls 3300 may include research questions on the interconnection posed to power industry insiders. Further, the polls 3300 gather primary data. The primary data to be gathered for this research was initially planned to be obtained using qualitative methods. The idea was to find some experts in the two most important fields for this topic: interconnection processes and blockchain. For the first one, Interconnection processes experts are not very common, but working in the power utility sector allows to have contact with some of them. For the second one, blockchain experts, blockchain is an emerging technology and therefore there are not many experts on the matter. And if finding experts on any of those topics separately is not easy, finding experts in both matters seemed almost impossible.

A survey was prepared to ask questions about the current transmission network interconnection processes, their disadvantages, the centralization role of ISO/RTOs, and alternatives using new technologies like blockchain. However, the acceptance response to participate in a survey from the interconnection processes experts group was too low. Therefore, envisioning what would happen for a similar check with the blockchain experts group, the decision was made to change from a qualitative survey method via email to a hybrid solution (quantitative/qualitative mix) taking advantage of the existing professional-social networks (in this particular case, several polls were published using the author's account for one professional network on the internet), with the hope that the questions would reach to more experts and a higher level of participation would be obtained.

There were limitations that needed to be overcome before using this method:
There is a limit on the number of characters that can be used when creating a poll in this internet professional network for other members to participate, for both the question and the answers, so they need to be well thought out in advance.
Polls can be published for everyone or for private groups.
Many polls at the same time may overwhelm and disengage some experts if published all at the same time.
Duration time for the polls to be open needs to be defined before publishing them. The longer they are open, the more experts may respond, but they lose interest over time.

It was decided to publish a carefully prepared poll and possible answers for experts to participate once a week, maintaining them open for a period of one week each if possible. Multiple choice polls were prepared to try to obtain both quantitative and relatively qualitative data. The polls were published open to any member of the professional online network to respond but a specific call for experts on the matter was explicitly made at the same time as the poll was published.

Quantitative data that has been taken into consideration is the number of experts responding, and how many were in favor or against the proposal in the poll question. In order to gather some qualitative data as well, available responses were not just “yes” or “no” answers, but there were at least two responses in favor, highlighting some advantages, and two negative responses, highlighting different disadvantages each. A total of four polls were published. The first one is about opinion on current interconnection processes in place in the U.S. (as shown in FIG. 33); the second one is about utilities and transmission network participants adopting a common network model in their companies; the third one asks opinions about using blockchain technology for maintaining current ISOs/RTOs transmission network models, and the last one a simple direct question about if current interconnection processes in place can be improved.

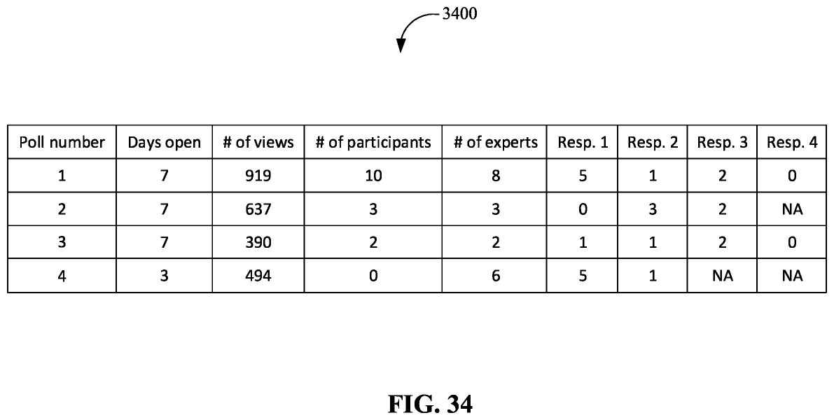

FIG. 34 is a table 3400 illustrating quantitative and qualitative data obtained after the three polls. Before concluding on the data obtained from the qualitative part of the primary data analysis, first, the quantitative part should be analyzed. Based on the number of views for each of the polls, they have reached more people than initially expected. However, looking at the number of people participating, the ratio of participants versus viewers is really low (1% is the highest ratio of the four). Also, to give validity to the responses, only the responses of those participants who can be considered experts in the field under discussion have been considered in the analysis.

The conclusion is that not enough experts have responded to take the responses received as a confirmed reflection of what the expert community thinks. However, the contrary cannot be confirmed either. The summary of the responses received is:
a) Current ISOs/RTOs interconnection processes in place are seen as inefficient, expensive, and slow.
b) Utilities are not adopting common network models to have a single source of information for the different departments in the company, and they are not planning on doing so in the future.
c) Sentiment about using blockchain technology to maintain and develop ISO/RTO transmission network model seems a great idea but with some security concerns.
d) Participants strongly believe that current interconnection processes can be improved.

Based on data in the table 3400 and (Box, 2014), the primary data gathered is considered with caution, and most of the ideas, facts, current tendencies, and opinions are considered from secondary data.

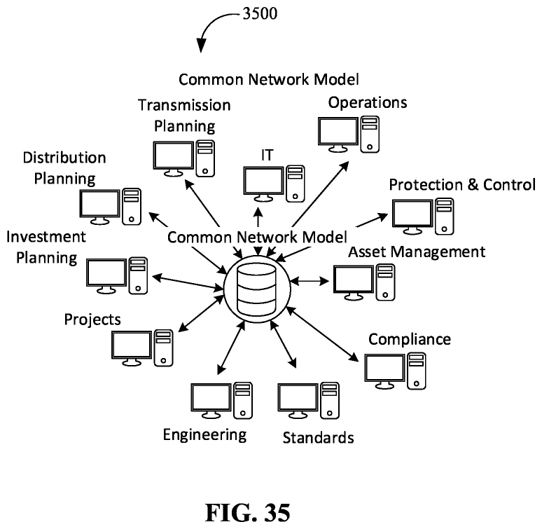

FIG. 35 illustrates a Common Network Model 3500 for different departments in a Power Utility. Further, the Common Network Model 3500 may perform operations, transmission planning, distribution planning, investment planning, projects, engineering, standards, compliance, asset management, and protection and control. Further, the database may include Line rating, Substation equipment with rating and characteristics, Relays and relay settings, Historic of incident reports, Maintenance and operation records/info, Substation as-built drawings, Outages info/records, NERC Compliance info, etc. Each department shall access the information in the database/common network model 3500 using their specific software programs via APIs.

Most power utilities in the U.S. do not have a network model and database with information replicating the transmission power grid common to the different company departments to access and maintain (as shown in the table 3400). Instead, transmission planning, protection and control, asset management, energy control center, operations, etc., and other utility company departments, usually have their own network model in their own database. They use different software programs to access this database and use that information: Protection and Control departments can calculate protection settings and simulate faults to confirm protection relays are coordinated; Transmission planning can evaluate and identify future projects to invest in by simulating future conditions in the model and running load flows and fault cases; etc. Not having a common source of truth for all those departments in the company and working on silos bring inefficiencies, as work is duplicated and there are greater probabilities of mismatches and human error when maintaining the information. In (Gonzalo Moreno, 2020), a Common Network model with a single database with the information used by the different departments in a power utility is proposed. Each department can access and maintain the common database using their specific piece of software and APIs as necessary.

Developed using blockchain technology, the idea is that, although the first step is for each specific transmission power utility to use it, the next goal is for all participants in the transmission network region to use it as well, and the final goal is for the whole U.S. (and part of Canada and Mexico—refer to FIG. 28) to use it as well. With this solution, we are moving from a competitive model inside utility companies and with the rest of the utilities and transmission network participants to a collaborative model, which optimizes the use of the resources.

One format for such database in the blockchain could be using CIM model, developed by EPRI and adopted by IEC, or SCL model, developed by IEC TC 57, or a mix of both, but first, a deep analysis would be necessary to check that it covers all the needs for all transmission participants and their departments.

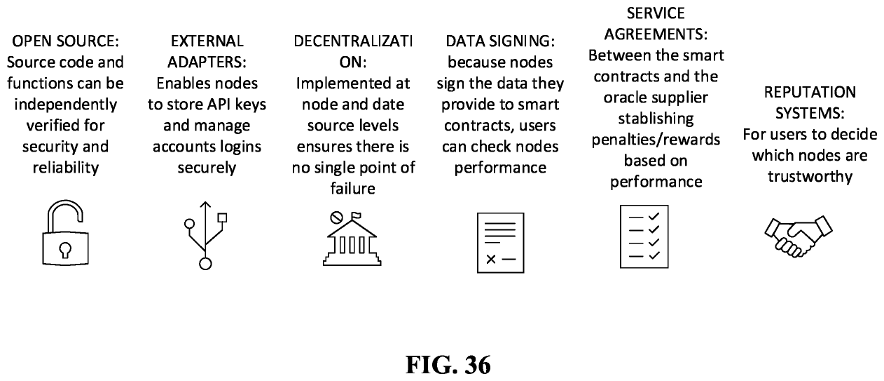

FIG. 36 illustrates main characteristics of the chainlink network. The proposal is to use Chainlink. Chainlink is a decentralized network of oracles that feeds real-world data to blockchain-based smart contracts (Takyar, 2021).

Chainlink can be understood as the link between the current world of data and the emerging blockchain technology. As Chainlink solves the blockchain oracle problem, it has positioned itself as the leader of oracles networks for blockchain-based networks, the industry standard oracle network. Chainlink can verify the data from oracles in a decentralized fashion, so when it is fed to the smart contracts, the single point of failure and the threat of unreliable data have already disappeared.

Chainlink was created by Sergey Nazarov in 2017 and it is built on Ethereum. It uses LINK tokens (ERC-20 tokens) to reward node operators when they get data from oracles, verify the data and provide that data to smart contracts.

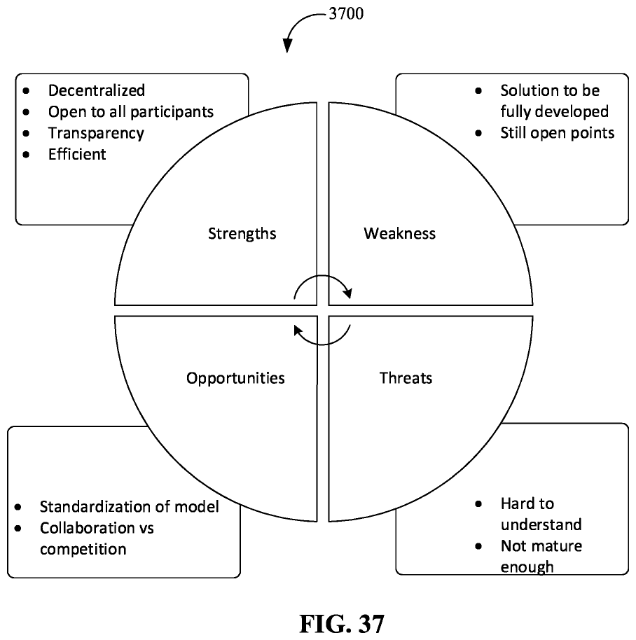

FIG. 37 illustrates a SWOT analysis 3700 of the new interconnection process, in accordance with some embodiments. One way of analyzing a new approach is preparing a SWOT (Strengths, Weakness, Opportunities, and Threats) analysis. The Strengths and Opportunities are far more significant than the Weakness and Threats, and together with the results of the PROS/CONS analysis, a deeper research should be carried out to better define the solution and to estimate the costs and duration for developing a first version of the blockchain and the smart contracts in it.

A better way of working with the critical infrastructure which is the transmission power network in the U.S. is possible. Long queues, slow procedures, lack of experienced resources, costly processes, etc., can be greatly mitigated with a modern solution that automates many of the steps while providing security, transparency, and trust.

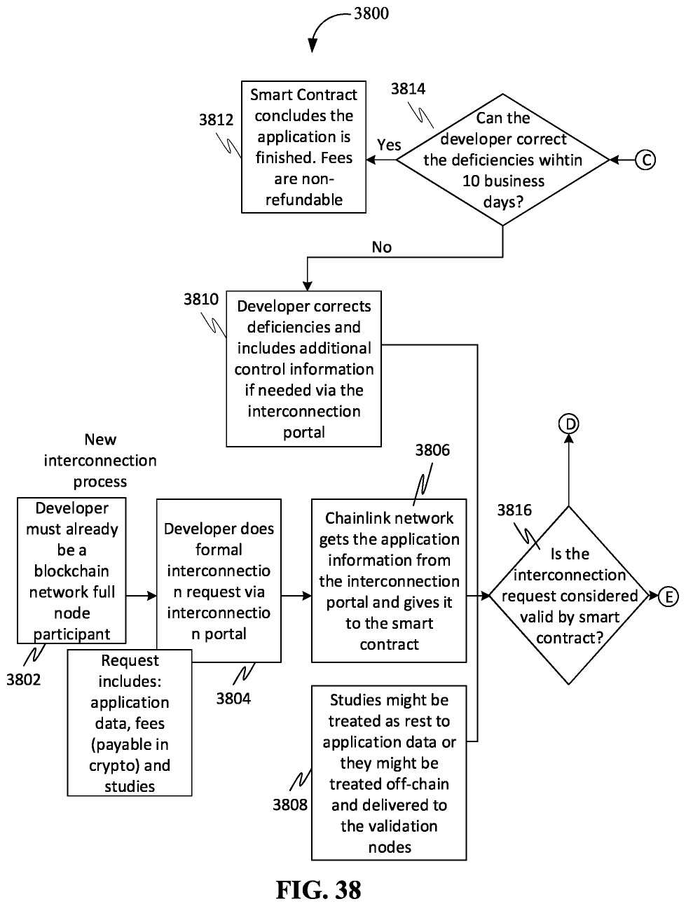

FIG. 38 is a flow diagram of a new process 3800 for NYISO interconnection, in accordance with some embodiments. Further, the new process 3800 may include a step 3802 of the developer must already be a blockchain network, full node participant. Further, the new process 3800 may include a step 3804 of the developer doing a formal interconnection request via the interconnection portal. Further, the new process 3800 may include a step 3806 of the chainlink network getting the application information from the interconnection portal and giving it to the smart contract. Further, the new process 3800 may include a step 3808 of studies being treated as rest to application data or they might be treated off-chain and delivered to the validation nodes. Further, the new process 3800 may include a step 3810 of developer correcting deficiencies and including additional control information if needed via the interconnection portal. Further, the new process 3800 may include a step 3816 receiving input from the step 3806, 3808, and 3810 and deciding if the interconnection request is considered valid by a smart contract. If not, the new process 3800 continues to a step 3818 of sending smart contract output via oracle/API to a messaging application to the developer indicating a deficient application info submission. Further, the new process 3800 continues to a step 3814 of deciding can the developer correct the deficiencies within 10 business days, if yes the new process 3800 continues to a step 3812 of smart contract concluding the application as finished and fees are non-refundable and if not, the new process 3800 continues to the step 3810. After the step 3816, if yes, the new process 3800 continues to a step 3824 of accepting project/interconnection request and adding it to the interconnection queue. Further, the new process 3800 may include a step 3822 of validating nodes in the blockchain network review the studies received and also the new block proposed with the addition of the new project to be connected to the transmission network. Further, the new process 3800 may include a step 3832 of deciding if a consensus was reached about connecting the new project? if no, the new process 3800 continues to a step 3830 of informing developer (output of smart contract, then Chainlink uses API to the corresponding external application). Further, the new process 3800 may include a step 3828 of sending off changes if the changes are proposed and if not implemented via smart contracts and chainlink. Further, the new process 3800 may include a step 3826 of developer considering changes proposed and Adapting studies if necessary. After the step 3826 the new process 3800 leads to the step 3822. After the step 3832, if yes, the new process 3800 may include a step 3834 adding the new block containing the addition of the new project to the transmission network model to blockchain. Further, the new process 3800 may include a step 3820 of broadcasting the updated blockchain to all nodes in the blockchain network.

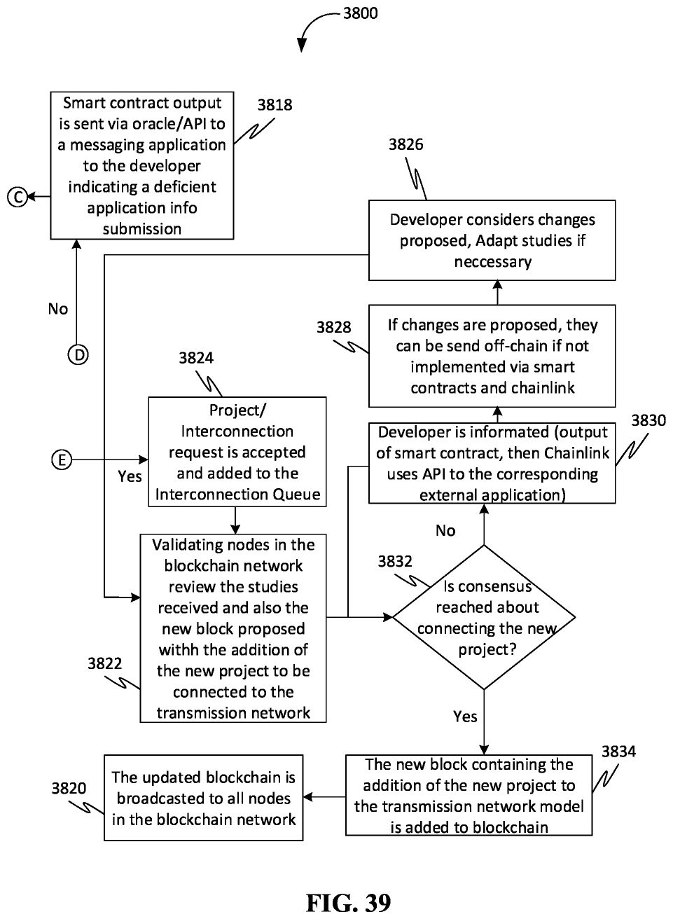

FIG. 39 is a continuation flow diagram of the new process 3800 for the NYISO interconnection, in accordance with some embodiments.

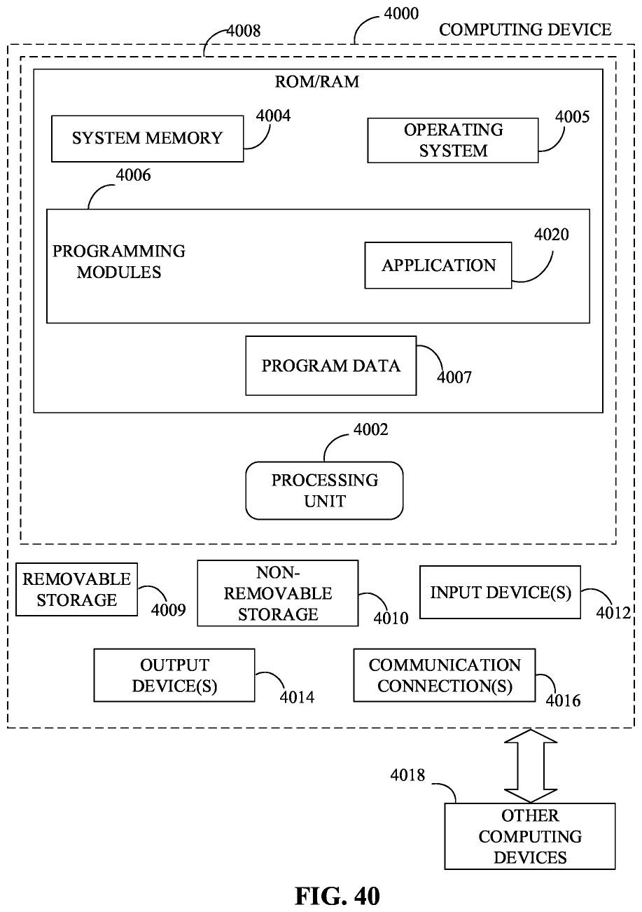

With reference to FIG. 40, a system consistent with an embodiment of the disclosure may include a computing device or cloud service, such as computing device 4000. In a basic configuration, computing device 4000 may include at least one processing unit 4002 and a system memory 4004. Depending on the configuration and type of computing device, system memory 4004 may comprise, but is not limited to, volatile (e.g. random-access memory (RAM)), non-volatile (e.g. read-only memory (ROM)), flash memory, or any combination. System memory 4004 may include operating system 4005, one or more programming modules 4006, and may include a program data 4007. Operating system 4005, for example, may be suitable for controlling computing device 4000's operation. In one embodiment, programming modules 4006 may include image-processing module, machine learning module. Furthermore, embodiments of the disclosure may be practiced in conjunction with a graphics library, other operating systems, or any other application program and is not limited to any particular application or system. This basic configuration is illustrated in FIG. 40 by those components within a dashed line 4008.

Computing device 4000 may have additional features or functionality. For example, computing device 4000 may also include additional data storage devices (removable and/or non-removable) such as, for example, magnetic disks, optical disks, or tape. Such additional storage is illustrated in FIG. 40 by a removable storage 4009 and a non-removable storage 4010. Computer storage media may include volatile and non-volatile, removable and non-removable media implemented in any method or technology for storage of information, such as computer-readable instructions, data structures, program modules, or other data. System memory 4004, removable storage 4009, and non-removable storage 4010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 4000. Any such computer storage media may be part of device 4000. Computing device 4000 may also have input device(s) 4012 such as a keyboard, a mouse, a pen, a sound input device, a touch input device, a location sensor, a camera, a biometric sensor, etc. Output device(s) 4014 such as a display, speakers, a printer, etc. may also be included. The aforementioned devices are examples and others may be used.

Computing device 4000 may also contain a communication connection 4016 that may allow device 4000 to communicate with other computing devices 4018, such as over a network in a distributed computing environment, for example, an intranet or the Internet. Communication connection 4016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 4004, including operating system 4005. While executing on processing unit 4002, programming modules 4006 (e.g., application 4020) may perform processes including, for example, one or more stages of methods, algorithms, systems, applications, servers, databases as described above. The aforementioned process is an example, and processing unit 4002 may perform other processes. Other programming modules that may be used in accordance with embodiments of the present disclosure may include machine learning applications. Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

### ABBREVIATIONS

1. API: Application Programming Interface
2. BFT: Byzantine Fault Tolerance
3. BTC: Bitcoin
4. CAMS: Customer and Asset Management System
5. CAPEX: Capital Expenditure
6. CEI: Critical Energy Infrastructure Information
7. CIM: Common Interface Model
8. CIP: Critical Infrastructure Protection
9. COD: Commercial Operation Date
10. CRIS: Capacity Resource Interconnection Service
11. DER: Distributed Energy Resources
12. DoE: Department of Energy
13. EIA: US Energy Information Administration
14. EPRI: Electric Power Research Institute
15. ERC-20: Ethereum Request for Comments 20
16. ERIS: Energy Resource Interconnection Service
17. ERO: Electrical Reliability Organization
18. ETH: Ether
19. FBA: Federated Byzantine Agreement
20. FERC: Federal Energy Regulatory Commission
21. FFS: Full Feasibility Study
22. IA: Interconnection Agreement
23. IC: Interconnection Customer
24. IEC: International Electrotechnical Commission
25. IoT: Internet of Things
26. ISD: In Service Date
27. ISO: Independent System Operator
28. ISO-NE: Independent System Operator—New England
29. LFIP: Large Facility Interconnection Procedures
30. LFS: Limited Feasibility Study
31. LLC: Limited Liability Company
32. NERC: North American Electric Reliability Corporation
33. NYISO: New York Independent System Operator
34. OPEX: Operating Expenditure
35. PBFT: Practical Byzantine Fault Tolerance
36. PoA: Proof of Authority
37. PoET: Proof of Elapsed Time
38. POI: Point of Interconnection
39. PoS: Proof of Stake
40. PoW: Proof of Work
41. PPA: Power Purchase Agreement
42. PSSE: Power System Simulator for Engineering
43. RTO: Regional Transmission Organization
44. SCL: Substation Configuration Language
45. SGIP: Small Generator Interconnection Procedures
46. SIS: System Impact Study
47. SO: System Operator
48. SRIS: System Reliability Impact Study
49. TC: Technical Committee
50. TO: Transmission Owner
51. TPS: Transactions Per Second
52. US: United States
53. USA: United States of America

The following is claimed:

1. A method for facilitating managing interconnection processes on a power transmission network, the method comprising:
receiving, using a communication device, at least one request from at least one device associated with at least one entity, wherein the at least one entity wants to connect at least one electrical equipment to at least one power transmission network;
retrieving, using a storage device, a transmission network data associated with the at least one power transmission network from a distributed ledger based on the at least one request;
analyzing, using a processing device, the at least one request and the transmission network data;
generating, using the processing device, an updated transmission network data of the at least one power transmission network based on the analyzing of the at least one request and the transmission network data, wherein the updated transmission network data reflects an impact on the at least one power transmission network by connecting the at least one electrical equipment to the at least one power transmission network;
transmitting, using the communication device, the updated transmission network data to at least one second device, wherein the at least one second device is associated with a plurality of validators;
receiving, using the communication device, at least one response corresponding to the updated transmission network data from the at least one second device;
analyzing, using the processing device, the at least one response using at least one machine learning model, wherein the at least one machine learning model is based on a consensus algorithm;
generating, using the processing device, a validation status of the at least one request for the connecting of the at least one electrical based on the analyzing of the at least one response;
transmitting, using the communication device, the validation status to at least one of the at least one device and the at least one second device; and
storing, using the storage device, at least one of the at least one response, the updated transmission network data, the validation status, and the at least one request in the distributed ledger.

2. The method of claim 1 further comprising:
transmitting, using the communication device, the transmission network data to the at least one device;
receiving, using the communication device, a user proposed transmission network data corresponding to the transmission network data from the at least one device;
transmitting, using the communication device, the user proposed transmission network data to the at least one second device;
receiving, using the communication device, at least one second response corresponding to the user proposed transmission network data from the at least one second device;
analyzing, using the processing device, the at least one second response using at least one second machine learning model;
determining, using the processing device, a validity of the user proposed transmission network data based on the analyzing of the at least one second response; and
transmitting, using the communication device, the validity of the user proposed transmission network data to the at least one device, wherein the generating of the validation status is further based on the validity of the user proposed transmission network data.

3. The method of claim 1, wherein the at least one request comprises at least one equipment specification corresponding to the at least one electrical equipment, wherein the at least one equipment specification comprises a kVA rating, a primary voltage, a full load current, a number of phases, a length of line, and a type of conductor.

4. The method of claim 1 further comprising:
retrieving, using the storage device, at least one compliance data associated with at least one electrical compliance organization;
analyzing, using the processing device, the at least one compliance data; and
determining, using the processing device, a validity of the at least one response based on the analyzing of the at least one compliance data and the analyzing of the at least one response, wherein the generating of the validation status of the at least one request is further based on the validity of the at least one response.

5. The method of claim 1 further comprising:
retrieving, using the storage device, at least one compliance data associated with at least one electrical compliance organization;
analyzing, using the processing device, the at least one request based on the at least one compliance data; and
determining, using the processing device, a request validity of the at least one request based on the analyzing of the at least one request based on the at least one compliance data, wherein the retrieving of the transmission network data is further based on the request validity.

6. The method of claim 1 further comprising:
receiving, using the communication device, at least one sensor data associated with the at least one electrical equipment from at least one sensor, wherein the at least one sensor is configured for generating the at least one sensor data based on detecting a value of at least one electrical parameter associated with the at least one electrical equipment;
analyzing, using the processing device, the at least one sensor data and the updated transmission network data;
generating, using the processing device, a violation alert corresponding to the updated transmission network data based on the analyzing of the at least one sensor data and the updated transmission network data; and
transmitting, using the communication device, the violation alert to the at least one of the at least one device and the at least one second device.

7. The method of claim 1, wherein the at least one electrical equipment comprises at least one renewable energy equipment, wherein the method further comprising:
receiving, using the communication device, at least one second sensor data from at least one second sensor associated with the at least one renewable energy equipment, wherein the at least one second sensor is configured for generating the at least one second sensor data based on detecting a value of at least one electrical parameter associated with the at least one renewable energy equipment;
receiving, using the communication device, at least one third sensor data from at least one third sensor, wherein the at least one third sensor is electrically coupled to each electrical equipment of a plurality of electrical equipment connected to the at least one power transmission network, wherein the at least one third sensor is configured for generating the at least one third sensor data based on detecting a value of at least one equipment electrical parameter associated with each of the plurality of electrical equipment;
analyzing, using the processing device, the at least one second sensor data and the at least one third sensor data;
generating, using the processing device, a load balance status corresponding to an electrical load applied on the at least one power transmission network by the plurality of electrical equipment; and
transmitting, using the communication device, the load balance status to the at least one second device, wherein the transmission network data comprises the load balance status.

8. The method of claim 1, wherein the validation status comprises one of a positive validation status and a negative validation status, wherein the positive validation status corresponds to an approval of the at least one request for the connecting of the at least one electrical equipment to the at least one power transmission network, wherein the negative validation status corresponds to a rejection of the at least one request for the connecting of the at least one electrical equipment to the at least one power transmission network.

9. The method of claim 8, wherein the method further comprising:
retrieving, using the storage device, a smart contract based on the positive validation status;
executing, using the processing device, the smart contract based on the retrieving of the smart contract;
generating, using the processing device, a payment notification based on the executing of the smart contract, wherein the payment notification comprises an interconnection fee for the connecting of the at least one electrical equipment to the at least one power transmission network;
transmitting, using the communication device, the payment notification to the at least one device;
receiving, using the communication device, a payment information corresponding to the payment notification from the at least one device;
processing, using the processing device, a transaction for the interconnection fee based on the payment information and the payment notification;
generating, using the processing device, a transaction confirmation based on the processing of the transaction; and
storing, using the storage device, the payment notification, the transaction confirmation, and the payment information in the distributed ledger.

10. The method of claim 9, wherein the payment information comprises a digital wallet information associated with at least one digital wallet, wherein the at least one digital wallet stores at least one cryptocurrency, wherein the processing of the transaction further comprises processing a cryptographic transaction for the interconnection fee based on the digital wallet information and the payment notification, wherein the method further comprises storing, using the storage device, the digital wallet information in the distributed ledger.

11. A system for facilitating managing interconnection processes on a power transmission network, the system comprising:
a communication device configured for:
receiving at least one request from at least one device associated with at least one entity, wherein the at least one entity wants to connect at least one electrical equipment to at least one power transmission network;
transmitting an updated transmission network data to at least one second device, wherein the at least one second device is associated with a plurality of validators;
receiving at least one response corresponding to the updated transmission network data from the at least one second device; and
transmitting a validation status to at least one of the at least one device and the at least one second device;
a processing device communicatively coupled to the communication device, wherein the processing device is configured for:
analyzing the at least one request and a transmission network data;
generating the updated transmission network data of the at least one power transmission network based on the analyzing of the at least one request and the transmission network data, wherein the updated transmission network data reflects an impact on the at least one power transmission network by connecting the at least one electrical equipment to the at least one power transmission network;
analyzing the at least one response using at least one machine learning model, wherein the at least one machine learning model is based on a consensus algorithm; and
generating the validation status of the at least one request for the connecting of the at least one electrical based on the analyzing of the at least one response; and
a storage device communicatively coupled with the processing device, wherein the storage device is configured for:
retrieving the transmission network data associated with the at least one power transmission network from a distributed ledger based on the at least one request; and
storing at least one of the at least one response, the updated transmission network data, the validation status, and the at least one request in the distributed ledger.

12. The system of claim 11, wherein the communication device is further configured for:
transmitting the transmission network data to the at least one device;
receiving a user proposed transmission network data corresponding to the transmission network data from the at least one device;
transmitting the user proposed transmission network data to the at least one second device;
receiving at least one second response corresponding to the user proposed transmission network data from the at least one second device; and
transmitting a validity of the user proposed transmission network data to the at least one device, wherein the generating of the validation status is further based on the validity of the user proposed transmission network data, wherein the processing device is further configured for:
analyzing the at least one second response using at least one second machine learning model; and
determining the validity of the user proposed transmission network data based on the analyzing of the at least one second response.

13. The system of claim 11, wherein the at least one request comprises at least one equipment specification corresponding to the at least one electrical equipment, wherein the at least one equipment specification comprises a kVA rating, a primary voltage, a full load current, a number of phases, a length of line, and a type of conductor.

14. The system of claim 11, wherein the storage device is further configured for retrieving at least one compliance data associated with at least one electrical compliance organization, wherein the processing device is further configured for:
analyzing the at least one compliance data; and
determining a validity of the at least one response based on the analyzing of the at least one compliance data and the analyzing of the at least one response, wherein the generating of the validation status of the at least one request is further based on the validity of the at least one response.

15. The system of claim 11, wherein the storage device is further configured for retrieving at least one compliance data associated with at least one electrical compliance organization, wherein the processing device is further configured for:
analyzing the at least one request based on the at least one compliance data; and
determining a request validity of the at least one request based on the analyzing of the at least one request based on the at least one compliance data, wherein the retrieving of the transmission network data is further based on the request validity.

16. The system of claim 11, wherein the communication device is further configured for:
receiving at least one sensor data associated with the at least one electrical equipment from at least one sensor, wherein the at least one sensor is configured for generating the at least one sensor data based on detecting a value of at least one electrical parameter associated with the at least one electrical equipment; and
transmitting a violation alert to the at least one of the at least one device and the at least one second device, wherein the processing device is further configured for:
analyzing the at least one sensor data and the updated transmission network data; and
generating the violation alert corresponding to the updated transmission network data based on the analyzing of the at least one sensor data and the updated transmission network data.

17. The system of claim 11, wherein the at least one electrical equipment comprises at least one renewable energy equipment, wherein the communication device is further configured for:
receiving at least one second sensor data from at least one second sensor associated with the at least one renewable energy equipment, wherein the at least one second sensor is configured for generating the at least one second sensor data based on detecting a value of at least one electrical parameter associated with the at least one renewable energy equipment;
receiving at least one third sensor data from at least one third sensor, wherein the at least one third sensor is electrically coupled to each electrical equipment of a plurality of electrical equipment connected to the at least one power transmission network, wherein the at least one third sensor is configured for generating the at least one third sensor data based on detecting a value of at least one equipment electrical parameter associated with each of the plurality of electrical equipment; and
transmitting a load balance status to the at least one second device, wherein the transmission network data comprises the load balance status, wherein the processing device is further configured for:
analyzing the at least one second sensor data and the at least one third sensor data; and
generating the load balance status corresponding to an electrical load applied on the at least one power transmission network by the plurality of electrical equipment.

18. The system of claim 11, wherein the validation status comprises one of a positive validation status and a negative validation status, wherein the positive validation status corresponds to an approval of the at least one request for the connecting of the at least one electrical equipment to the at least one power transmission network, wherein the negative validation status corresponds to a rejection of the at least one request for the connecting of the at least one electrical equipment to the at least one power transmission network.

19. The system of claim 11, wherein the storage device is further configured for:
retrieving a smart contract based on the positive validation status; and
storing a payment notification, a transaction confirmation, and a payment information in the distributed ledger, wherein the processing device is further configured for:
executing the smart contract based on the retrieving of the smart contract;
generating the payment notification based on the executing of the smart contract, wherein the payment notification comprises an interconnection fee for the connecting of the at least one electrical equipment to the at least one power transmission network;
processing a transaction for the interconnection fee based on the payment information and the payment notification; and
generating the transaction confirmation based on the processing of the transaction, wherein the communication device is further configured for:
transmitting the payment notification to the at least one device; and
receiving the payment information corresponding to the payment notification from the at least one device.

20. The system of claim 19, wherein the payment information comprises a digital wallet information associated with at least one digital wallet, wherein the at least one digital wallet stores at least one cryptocurrency, wherein the processing of the transaction further comprises processing a cryptographic transaction for the interconnection fee based on the digital wallet information and the payment notification, wherein the storage device is further configured for storing the digital wallet information in the distributed ledger.
